(19) United States
(12) Patent Application Publication
(10) Pub. No.: US 2026/0281209 A1
(43) Pub. Date: Sep. 17, 2026

(54) TECHNIQUE FOR TRANSMITTING DATA BURSTS OVER A COMMUNICATION PATH

(71) Applicant: Arm Limited, Cambridge (GB)

(72) Inventors: Daren CROXFORD, Swaffham Prior (GB); Michael Andrew CAMPBELL, Waterbeach (GB)

(21) Appl. No.: 19/077,309

(22) Filed: Mar. 12, 2025

(51) Int. Cl. H04L 69/04

(52) U.S. Cl. CPC H04L 69/04

(57) ABSTRACT

An apparatus has transmission circuitry for transmitting data over a communication path to a recipient device, and compression circuitry, responsive to a given data burst comprising a plurality N of data blocks associated with a sequence of addresses within a given address range, to determine, in dependence on compression criteria, whether to apply a compression scheme to the given data burst to cause one or more data blocks of the given data burst to be represented in a compressed form when transmitted over the communication path. The transmission circuitry is configured, absent the compression circuitry applying the compression scheme to the given data burst, to transmit the given data burst as a series of N beats over the communication path, where each beat is used to transmit a corresponding data block. Conversely, the transmission circuitry is configured, when the compression circuitry applies the compression scheme to the given data burst, to transmit the given data burst by transmitting over the communication path, in a given beat, metadata that comprises at least compression indication data to identify each data block of the given data burst that is in the compressed form, and to transmit at least any uncompressed data blocks of the given data burst in one or more further beats. The transmission circuitry is configured to notify the recipient device when the compression scheme has been applied to the given data burst.

### BACKGROUND

The present technique relates to the field of data processing, and more particularly to a technique for transmitting data bursts over a communication path.

In modern data processing systems, large amounts of data are passed over communication paths between elements in the system. To seek to increase the bandwidth of a communication path, it is often the case that the communication path is made wider to increase the amount of data that can be sent over the communication path in each clock cycle, and in addition the operating speed of the communication path may be increased. However, such measures increase cost and complexity of the communication path due to the increase in pin count required to accommodate the wider data paths, and also increase power consumption.

Such increases in path width and operating speed are seen in many areas, but one such example is in connection with the communication path between memory and a memory controller in a data processing system. Both the operating speed of the memory interface and the width of the memory interface have been increasing in modern data processing systems, and this has led to a significant increase in cost and complexity of the memory interface. However, the speed at which the individual memory elements within the memory can be accessed has not been increasing at the same rate, and in particular has not kept pace with the increase in performance of the memory interface. In order to make use of the higher performance memory interface, this has led to a need to access within the memory device wide chunks of data (significantly wider than the width of data that can be sent over the memory interface in a given clock cycle) that are fetched from the memory cells at a relatively low rate, with data then being passed between the memory controller and the memory in the form of a data burst comprising multiple data blocks sent over the memory interface at a relatively high frequency.

As the demand for higher and higher bandwidth increases, it is likely to become less desirable and/or practical to seek to accommodate those demands merely by increasing the width of the communication paths and/or the operating frequency of those communication paths, as the cost, complexity and power consumption requirements of such an approach are likely to become a significant issue in the design of future generations of data processing systems.

### SUMMARY

In accordance with a first example arrangement, there is provided an apparatus comprising: transmission circuitry configured to transmit data over a communication path to a recipient device; and compression circuitry, responsive to a given data burst comprising a plurality N of data blocks associated with a sequence of addresses within a given address range, to determine, in dependence on compression criteria, whether to apply a compression scheme to the given data burst to cause one or more data blocks of the given data burst to be represented in a compressed form when transmitted over the communication path; wherein: the transmission circuitry is configured, absent the compression circuitry applying the compression scheme to the given data burst, to transmit the given data burst as a series of N beats over the communication path, where each beat is used to transmit a corresponding data block; the transmission circuitry is configured, when the compression circuitry applies the compression scheme to the given data burst, to transmit the given data burst by transmitting over the communication path, in a given beat, metadata that comprises at least compression indication data to identify each data block of the given data burst that is in the compressed form, and to transmit at least any uncompressed data blocks of the given data burst in one or more further beats; and the transmission circuitry is configured to notify the recipient device when the compression scheme has been applied to the given data burst.

In accordance with a second example arrangement, there is provided a method of transmitting data bursts over a communication path to a recipient device, comprising: employing compression circuitry to determine, for a given data burst comprising a plurality N of data blocks associated with a sequence of addresses within a given address range, in dependence on compression criteria, whether to apply a compression scheme to the given data burst to cause one or more data blocks of the given data burst to be represented in a compressed form when transmitted over the communication path; absent the compression circuitry applying the compression scheme to the given data burst, transmitting the given data burst as a series of N beats over the communication path, where each beat is used to transmit a corresponding data block; when the compression circuitry applies the compression scheme to the given data burst, transmitting the given data burst by transmitting over the communication path, in a given beat, metadata that comprises at least compression indication data to identify each data block of the given data burst that is in the compressed form, and transmitting at least any uncompressed data blocks of the given data burst in one or more further beats; and notifying the recipient device when the compression scheme has been applied to the given data burst.

In accordance with a further example arrangement, there is provided a system comprising: an apparatus in accordance with the first example arrangement discussed above, implemented in at least one packaged chip; at least one system component; and a board, wherein the at least one packaged chip and the at least one system component are assembled on the board. In an additional example arrangement, the above-mentioned system may be assembled on a further board with at least one other product component.

In a yet further example arrangement, there is provided a computer-readable medium storing computer-readable code for fabrication of an apparatus in accordance with the first example arrangement discussed above. The computer-readable medium may be a transitory computer-readable medium (such as wired or wireless transmission of code over a network) or a non-transitory computer-readable medium such as semiconductor, magnetic disk, or optical disc.

### BRIEF DESCRIPTION OF THE DRAWINGS

Further aspects, features and advantages of the present technique will be apparent from the following description of examples, which is to be read in conjunction with the accompanying drawings, in which:

FIG. 1 is a block diagram of a data processing system in accordance with one example implementation;

FIG. 2 is a block diagram illustrating a synchronous dynamic random access memory (SDRAM);

FIG. 3 schematically illustrates how data in a data output register of an SDRAM may be output over a memory interface as a data burst comprising multiple data blocks, with each data block sent in a separate beat;

FIG. 4 is a block diagram illustrating a memory controller and associated memory device in accordance with one example implementation;

FIG. 5 is a flow diagram illustrating steps taken by a transmitting device coupled to a communication path when determining how to transmit a data burst over the communication path, in accordance with one example implementation;

FIG. 6 illustrates, by way of specific example, one form of compression scheme that may be used in an example implementation;

FIG. 7 is a block diagram illustrating the use of a history buffer by both a transmitter and a receiver coupled via a communication path, when adopting a history buffer based compression scheme that may be used in an example implementation;

FIG. 8 illustrates, by way of specific example, a history buffer based compression scheme that may be used in an example implementation;

FIG. 9A illustrates the contents of the history buffer following transmission of the data burst illustrated in FIG. 8, in accordance with one example implementation, whilst FIG. 9B schematically illustrates the sequence of updates to the history buffer that arise during the processing of the data burst shown in FIG. 8;

FIG. 10 illustrates, by way of specific example, a history buffer based compression scheme that may be used in another example implementation;

FIG. 11 illustrates the contents of the history buffer following transmission of the data burst illustrated in FIG. 10, in accordance with one example implementation;

FIG. 12 schematically illustrates how one or more common values may be locked into entries of a history buffer, in accordance with one example implementation;

FIG. 13 illustrates, by way of specific example, another form of compression scheme that may be used in an example implementation;

FIG. 14 illustrates, by way of specific example, another form of compression scheme that may be used in an example implementation;

FIG. 15 schematically illustrates how data bursts may be stored within a memory device in compressed form, in accordance with one example implementation;

FIGS. 16A and 16B illustrate the timing of write commands in accordance with a first and a second example implementation;

FIGS. 17A and 17B illustrate the timing of read commands in accordance with a first and a second example implementation;

FIGS. 18A and 18B illustrate the relative timing between adjacent write and read commands in accordance with one example implementation; and

FIG. 19 illustrates a system and a chip-containing product.

### DESCRIPTION OF EXAMPLES

In accordance with one example implementation, there is provided an apparatus comprising transmission circuitry configured to transmit data over a communication path to a recipient device. In addition, compression circuitry is provided that is arranged, responsive to a given data burst comprising a plurality N of data blocks associated with a sequence of addresses within a given address range, to determine, in dependence on compression criteria, whether to apply a compression scheme to the given data burst to cause one or more data blocks of the given data burst to be represented in a compressed form when transmitted over the communication path.

The communication path could take a variety of forms, in principle being any communication path where it is desired to transmit data bursts over that communication path. However, by way of illustrative example, the communication path could take the form of a memory interface used to couple a memory controller to a memory device. In one such example implementation the given address range could correspond to a row or a sub-row's worth of data prefetched into an internal row buffer within a memory device, as will occur when a row within the memory device is activated/opened. Once a row has been activated, a data burst can be used to write data to a sequence of addresses within the activated row, or to read data from the sequence of addresses within the activated row. Whilst the sequence of addresses could be sequential addresses in memory, this is not a requirement, and the sequence of addresses could take any suitable form, for example a predefined pattern of addresses within the given address range identified in a suitable manner, for instance via specification of a defined access pattern and a start address.

The memory device could take a variety of forms, for example SDR-SDRAM, DDRx-SDRAM, LPDDRx-SDRAM (low power variant), GDDRx-SDRAM, HBM (High Bandwidth Memory), HBM2, etc.

As noted above, in accordance with the techniques described herein, the compression circuitry is arranged to determine whether to apply a compression scheme to the given data burst or to leave the data burst uncompressed. If the compression scheme is used, then this will result in one or more data blocks of the given data burst being represented in a compressed form when transmitted, thereby reducing the amount of data that needs to be sent over the communication path when transmitting the given data burst. The compression criteria used to determine whether to apply the compression scheme or not could take a variety of forms, dependent on implementation. However, by way of illustrative example, it may be the case that the compression circuitry decides to apply the compression scheme only if as a result of applying the compression scheme the total number of beats required to transmit the given data burst is reduced by at least a predetermined percentage.

In accordance with the techniques described herein, the transmission circuitry is configured, when the compression circuitry determines that the compression scheme should not be applied to the given data burst, to transmit the given data burst as a series of N beats over the communication path, where each beat is used to transmit a corresponding data block. However, if instead the compression circuitry determines that the compression scheme should be applied to the given data burst, the transmission circuitry is configured to transmit the given data burst by transmitting over the communication path, in a given beat, metadata that comprises at least compression indication data to identify each data block of the given data burst that is in the compressed form, and to transmit at least any uncompressed data blocks of the given data burst in one or more further beats. Further, the transmission circuitry is configured to notify the recipient device when the compression scheme has been applied to the given data burst.

The given beat in which the metadata is provided may vary dependent on implementation, but in one example implementation is the first beat of the data burst (in some instance the metadata may not occupy all of the first beat), thereby enabling the recipient device to receive the metadata prior to receiving any further beats of data required for the given data burst. This can therefore allow the recipient to calculate the length of the data burst earlier than would otherwise be the case. Whilst in one example implementation the compression indication data may be the only information provided as metadata in the given beat, in other example implementations there could also be additional information that forms part of that metadata. Such additional information may for example be used to identify the compression scheme used if more than one compression scheme is supported, to identify the burst length if that is not predefined (for example it could be predefined as a value set within a control register), etc.

There are various ways in which the transmission circuitry can be arranged to notify the recipient device when the compression scheme has been applied to the given data burst. This could for example be done by differentiating, in the associated command used to initiate the given data burst, between a scenario where the given data burst is being transmitted uncompressed and a scenario where the given data burst is being transmitted in a compressed format. For example, when writing data from a memory controller to a memory device, the system may support both a write command and a separate write-compressed command to enable a differentiation to be made between the writing of an uncompressed data burst and the writing of a compressed data burst.

As noted above, in addition to the metadata transmitted in the given beat, any uncompressed data blocks will be transmitted in one or more further beats. Depending on the data values of the various data blocks forming the given data burst, it will be appreciated that there may or may not be uncompressed data blocks, and so whether one or more further beats are needed to transmit uncompressed data blocks will depend on the given data burst in question.

Irrespective of whether one or more further beats are needed to transmit any uncompressed data blocks, in one example implementation the transmission circuitry is further configured, in situations where the compression circuitry applies the compression scheme to the given data burst, to transmit over the communication path, in one or more additional beats, supplementary information sufficient to enable the recipient device to determine the data value of each data block that is in the compressed form. As will be apparent from the later discussions of example compression schemes, in accordance with some compression schemes there may not be any need for such supplementary information, but in accordance with other compression schemes there will be a need for such supplementary information. This supplementary information can take various forms depending on the compression scheme in question. For instance, as will be apparent from the example compression schemes discussed later herein, examples of such supplementary information could be an indication of a history buffer entry, an offset value, a Golumb code, a small value represented in a reduced number of bits relative to an uncompressed data value, etc.

From the above discussion, it will be appreciated that when the compression scheme is applied, metadata will be provided in a given beat (e.g. the first beat), and depending on the data values within the beat, there may also be a need to transmit one or more uncompressed data blocks, and/or one or more items of supplementary information. When a high level of compression is achieved (for example in some instances it may be the case that only the metadata needs to be transmitted), it should be noted that in some implementations, even though the data bus would then be available on the next clock cycle, there may be an overriding minimum amount of time that the memory requires to perform its processing internally. The memory device may hence indicate (for example in its internal status registers) the minimum number of beats that a burst can have, and the memory controller will read and take account of that information when scheduling adjacent bursts.

Whilst in some implementations only a single compression scheme may be supported, with the compression circuitry deciding whether to apply that compression scheme or not for any given data burst dependent on the earlier-mentioned compression criteria, in other example implementations the compression circuitry may be arranged to select the compression scheme from amongst a plurality of compression schemes. In such implementations, the transmission circuitry may be arranged, when the compression circuitry applies the compression scheme to the given data burst, to signal to the recipient device which compression scheme amongst the plurality of compression schemes has been applied. There are various ways in which the transmission circuitry may notify the recipient device as to the compression scheme used. For instance, in implementations where a command is used to initiate a transaction involving a data burst, multiple different variants of a command type identifying that the data burst will be compressed may be supported, so that the form of command sent in situations where a compression scheme is being applied will indicate the compression scheme being used to compress the data burst. Alternatively, a single form of command identifying that the data burst will be compressed may be supported, with an indication of the compression scheme used being included within the metadata provided in the above-mentioned given beat. In another example implementation, a particular portion of the signals transmitted may be used to indicate whether a transfer is compressed or not, and if so, what type of compression is used. For example, all or part of this information could be provided within the portion of the signals used to supply column address bits in an SDRAM implementation.

In some instances, an additional benefit can be realised when using the above-mentioned latter approach of incorporating an indication of the compression scheme used within the metadata. For instance, in situations where the given data burst is provided over the communication path for storage in memory, and a compression scheme is applied to one or more data blocks of the given data burst, the given data burst may in some instances be able to be stored within the memory in its compressed format. Hence, if the indication of the compression scheme used is provided within the metadata, and thus is inherently included within the compressed format of the data burst, then that information about the compression scheme used will be stored within the memory as an inherent part of the compressed format of the data burst. In due course, when that compressed data burst is read from memory for output back to the memory controller over the memory interface, then the information about the compression scheme used will already be included within the information passed over the memory interface without the memory device needing to analyse the compressed format to determine the compression scheme used.

There are various ways in which the compression scheme to be used by the compression circuitry may be selected for any particular data burst, but in one example implementation the compression scheme applied by the compression circuitry to the given data burst is selected taking into account at least one of the following criteria: a type of data contained within the given data burst; a memory region associated with the given address range; and/or compression schemes supported by the recipient device. Where multiple compression schemes are available for selection, the compression circuitry may in some instances decide to try all of the compression schemes in order to see which scheme gives the best compression for the given data burst in question. Alternatively, based on one or more of the above-mentioned criteria, the compression circuitry may determine a subset of the available schemes to try for the given data burst in question, or indeed may determine a single scheme to try for the given data burst.

In accordance with the criteria set out above, selection of suitable compression schemes may be made dependent on what schemes are supported by the recipient device, and/or dependent on the type of data included within the given data burst, which may for example be dependent on the workload. For instance, if it is known that a machine learning workload is being performed, the data values processed may statistically include a significant number of zero values and small values, and that knowledge can be used to select one or more compression schemes to be considered when deciding whether to apply compression for the given data burst. Similarly, if it is known that graphics processing is being performed, then there is often a good degree of data locality in the data being processed, and this again can be used to determine which compression scheme or compression schemes are most appropriate to be considered when deciding whether to apply compression for the given data burst.

As a yet further example, whilst the memory device may be a general purpose memory device, some memory devices are used for specific purposes. For example graphics DDR (GDDR) memory is typically used with graphics processing units (GPUs) for graphics (and more recently machine learning) data, and hence if it is known that the memory controller will be communicating with GDDR memory, then the compression scheme or compression schemes supported can be chosen taking that fact into account. It may also be the case that the memory device may be programmed with certain other information that can be useful when determining whether compression should be applied. For example, if it is known that the data blocks being transferred actually represent multiple sub-elements (as for example may be the case with RGB or RGBA values), then information such as element and sub-element width may be written in memory control registers and that information can be used when determining a suitable compression scheme to employ and/or how the chosen compression scheme is applied (for example better compression may be achieved when considering the individual sub-elements across multiple data blocks, rather than viewing the data value provided in a data block as a single element).

As a still further example, the compression scheme or compression schemes selected for consideration may vary dependent on the memory regions in which the data of the data burst is stored, Such an approach can be useful, for example, if different regions of memory are associated with different workloads/data types. As a still further example, it may typically be the case that a lossless compression scheme is selected. However, in some instances it may be appropriate to consider a lossy compression scheme. For example, it is often the case that display data is subjected to a lossy compression scheme before that data is output to the display panel (to reduce the cost and power consumption of the display interface). Hence, when considering transfer of data to and from memory, if it is known that the data is display data, then it may be decided to consider a lossy compression scheme for a data burst since such an approach is unlikely to introduce any significant artefacts to the data given that the data will in any case be output to the display panel in a compressed format. In such cases the use of a lossy compression scheme may save energy when writing such display data to, and reading such display data from, memory.

When adopting the techniques described herein, various forms of compression scheme may be used. For instance, in one example implementation, in accordance with the compression scheme applied by the compression circuitry, at least one default value may be defined and identified to the recipient device, and the compression circuitry may be arranged to generate the compression indication data to identify, for each defined default value, each data block of the given data burst that has that default value. There are various ways in which the one or more default values could be defined and identified to the recipient device. For instance, they could be set in one or more control registers of the recipient device, for example via one or more earlier issued commands used to store data into such control registers. The default value or default values could in some instances be fixed, or could be programmable. In one example implementation it may be decided just to have a single default value, such as an all zeros value, but in some implementations it may be appropriate to have more than one default value. For example, an all zeros value and all ones value may be defined as two default values (this latter approach may for example be useful when handling small signed numbers).

As another example of a compression scheme that may be used, the apparatus may further comprise a data history buffer accessible to the compression circuitry, and used to store one or more data values output to the recipient device over the communication path. In accordance with such an implementation, the recipient device may be configured to reconstruct the data history buffer content using the data values received over the communication path. Further, in accordance with the compression scheme applied by the compression circuitry, the compression circuitry may be arranged to generate the compression indication data to identify each data block of the given data burst that has a data value matching a stored data value in an entry of the data history buffer, and for each identified data block to generate an entry indicator to identify the entry of the data history buffer in which the data value for that identified data block is stored. The transmission circuitry may then be configured, if the compression circuitry applies the compression scheme to the given data burst, to transmit over the communication path, in one or more additional beats, each entry indicator generated by the compression circuitry. Hence, in such a case, for each data block whose data value matches a stored data value in the data history buffer, it is merely necessary to send an indication of the entry within the data history buffer containing the data value, rather than needing to send the data value itself, which can significantly reduce the number of beats required to transfer the given data burst over the communication path to the recipient device.

Whilst the above approach can in one example implementation only be used for a data value that actually matches a stored data value in an entry of the data history buffer, in another example implementation the scheme can be extended to also enable compression in respect of data values that are close to data values stored in the data history buffer. In particular, in accordance with the compression scheme applied by the compression circuitry, the compression circuitry may be arranged to generate the compression indication data to additionally identify each data block of the given data burst that has a data value within a defined range of a stored data value in an entry of the data history buffer, and for each additionally identified data block to generate an entry indicator to identify the entry of the data history buffer, and an associated offset value to be applied to the data value stored in the identified entry in order to produce the data value for the additionally identified data block. The transmission circuitry may then be configured, if the compression circuitry applies the compression scheme to the given data burst, to transmit over the communication path, in the one or more additional beats, each entry indicator and the associated offset value generated by the compression circuitry. It has been found that significant compression can still be achieved even when needing to issue a small offset value in association with an entry indicator, when compared with sending data in uncompressed form. There are various ways in which the offset value can be specified. For example, it may be specified as a small binary value, as a Golomb code, etc.

In addition to the above two mentioned examples of compression scheme that may be used in some example implementations, other schemes may also be supported. For instance, a small value compression scheme may be used where, when considering data blocks comprising N bits, if it is noted that a particular data value is a small value, the N-bit representation of the value may be substituted with an M-bit representation, where M is less than N. As another example, other compression schemes that can represent small values in an efficient manner, such as a Golumb-coded scheme, may be supported, allowing significant compression to be achieved for data bursts that comprise a number of small data values.

It should also be noted that hybrid schemes could be employed, that make use of a number of the techniques mentioned above. By way of specific example, such a hybrid scheme could provide compression indication data to identify, for each data block, whether that data block is uncompressed, is identified by an entry in the data history buffer, is specified as a Golomb code, is identified by a combination of a data value identified in a data history buffer entry combined with a small offset value (which could for example be specified as a Golomb code), etc.

When adopting the earlier approach that uses a data history buffer to achieve compression, then if desired at least one entry in the data history buffer may be used to store a chosen defined data value and be prevented from being overwritten. Typically the data history buffer will have a relatively small size, and as new data values are encountered within a data stream, they may be added to the data history buffer, evicting older values. However, it can be beneficial to lock down certain common values in the data history buffer so that they are always available for reference. For example, an all zero value and/or an all one value could be locked into the data history buffer.

When considering an implementation where the communication path is used to communicate between a memory controller and a memory device, then it will be appreciated that data may be written to the memory device and also data may be read from the memory device. When adopting the earlier approach that uses a data history buffer, if desired separate data history buffers could be maintained for write data and read data. However, in an alternative implementation the data history buffer could be shared for write and read data, with that data history buffer then being referenced when performing both write operations and read operations.

When adopting such a data history buffer approach, then in some instances it may be appropriate to clear the contents of the data history buffer, for example to clear sensitive data before changing task and/or operating mode, or where the memory device and system have been placed in a low power mode, for example if the SDRAM has been placed into self-refresh mode and the memory controller has been powered down. The memory controller will therefore loose the state information of the history buffer. The memory controller will then request the memory device(s) to clear their history buffers so that both the memory device and memory controller are synchronised. In such instances, a command may be provided that can be used to clear the data history buffer as and when required.

In one example implementation, the apparatus may further comprise a transmission buffer to store a plurality of data bursts awaiting transmission over the communication path. It may be possible to reorder those data bursts to take account of the capabilities of the recipient device. For example, where the recipient device is a memory device, it may be the case that a row within the memory device is activated/opened, and that it is then beneficial to perform multiple accesses to data in that row before the row is closed to allow another row to be activated.

In accordance with one example implementation, this reordering capability can also be leveraged to improve compression efficiency. In particular, the compression circuitry may be arranged to reorder data bursts stored within the transmission buffer when such a reordering would enable an improvement in compression efficiency when applying a selected compression scheme to one or more data bursts amongst the plurality of data bursts. As a result of performing such reordering, this can hence improve the bandwidth of the communication path. For example, there can be a number of functions that involve sequences of write and read burst operations where there may be an expectation that similar data values will be provided. For example, memory copy (memcpy) functions typically use read-modify-write sequences and it is often the case that only a small number of data values are changed, such that the read burst data will be similar to the write burst data. In such instances it may be beneficial to perform reordering so that the read and the write operations are allocated close together, since this may enable better overall compression to be achieved when adopting a particular compression scheme. Similar benefits may also arise when performing atomic operations, which can also involve read-modify-write sequences, and where it can sometimes be beneficial to allocate atomic operations back to back if that enables an improvement in compression efficiency and hence an increase in the effective bandwidth of the communication path.

In one example implementation, in the presence of a defined condition, the compression circuitry is arranged, for each data block, to apply the compression scheme independently to the data bits in different subsets of the data block. There are some scenarios where such an approach can improve the compression efficiency that can be gained when applying the compression scheme. As one example, if it is known that the data consists of multiple distinct sub-elements (as for example is the case when the data in each data block provides RGB data), then it can be beneficial to apply the compression scheme independently to each of the sub-elements in the data block as this can enable a significant improvement in compression efficiency in certain situations, for example where similar data values in respect of each sub-element are expected across multiple data blocks (for example a sequence of R values are expected to be similar, a sequence of G values are expected to be similar and/or sequence of B values are expected to be similar). As another example, it may be the case that the memory system is constructed of multiple separate memory devices, with different portions of the communication path/bus connecting to different memory devices. In such instances, it may be known that different portions of the communication path are likely to carry data exhibiting different properties, and hence it can be appropriate to apply a compression scheme independently to one or more of those portions. For instance, in certain workloads, for example machine learning, data values tend to be skewed to small and zero values. In such instances, the high portion of a data word (i.e. a certain number of the most significant bits) are likely to be all zero (or for signed values all zero or all one). In one example implementation, the upper portions of the data bus could hence be driven with compressed values, whereas the lower portion could be driven with uncompressed values, thereby increasing the ability for the system to compress data.

In one example implementation, the transmission circuitry is arranged to issue a command to the recipient device in association with each data burst sent over the communication path, to identify to the recipient device how the associated data burst should be handled by the recipient device. When adopting such an approach, the transmission circuitry may be arranged, following transmission of a given command in association with the given data burst, to control timing of issuance of a next command for a next data burst to be transmitted after the given data burst, to take into account a number of beats required to transmit the given data burst, where the number of beats is dependent on a degree of compression achieved by the compression circuitry for the given data burst. Such an approach can improve utilisation of the communication path by reducing/avoiding periods of time where the communication path is unused, and as a result this can increase available bandwidth and hence increase throughput.

As noted earlier, the apparatus and the recipient device can take a variety of forms. However, in one example implementation, the apparatus is a memory controller, and the recipient device is a memory device. It has been found that significant improvements in available bandwidth and throughput can be achieved in respect of the memory interface communication path between the memory controller and the memory device, when adopting the techniques described herein.

Whilst in some implementations separate communication paths could be provided for writing data to the memory device and for reading data from the memory device, in one example implementation the apparatus is configured to use the communication path for both write data to be written to the memory device, and to receive read data read from the memory device. In such an implementation, the transmission circuitry may be arranged to issue a write command to the memory device in association with a data burst sent over the communication path comprising data to be written to the memory device, and may be configured to issue a read command to the memory device when requesting a data burst containing read data to be returned over the communication path from the memory device to the memory controller. If one considers then a scenario where the given data burst contains write data to be written to the memory device, and a next data burst to be sent over the communication path following the given data burst is a read data burst to provide read data read from the memory device, then the transmission circuitry can take steps to schedule the read command with the aim of more fully utilising the communication path. In particular, the transmission circuitry may be arranged, following transmission of a given write command in association with the given data burst, to control timing of issuance of a read command used to identify the next data burst to take into account a number of beats required to transmit the given data burst, where the number of beats is dependent on a degree of compression achieved by the compression circuitry for the given data burst. By taking such an approach, the transmission circuitry can seek to reduce any period of time where the communication path would otherwise be unused/idle between transmission of the write data burst to the memory device, and transmission of the subsequent read data burst from the memory device, thus enabling the communication path to be more fully utilised.

Whilst, as mentioned above, in one example implementation the apparatus may be a memory controller and the recipient device may be a memory device, in another example implementation the apparatus may be a memory device and the recipient device may be a memory controller. Indeed, in one particular example implementation, both the memory controller and the memory device may incorporate the features discussed above with reference to the described apparatus, allowing compression to be performed in both directions between the memory controller and the memory device.

In one example implementation where the apparatus is a memory device and the recipient device is a memory controller, the memory device may be arranged to generate a read data burst containing read data read from the memory device in response to a read command received from the memory controller. Whilst the memory controller has initiated the read by issuing the read command, it will not know whether the subsequently received read data burst will have had compression applied to it or not. However, the memory device will know this information, and in one example implementation the memory device is configured to transmit a sideband signal in association with the read data burst sent over the communication path, to indicate to the memory controller whether the compression scheme has been applied to the read data burst. The sideband signal can be implemented in a variety of ways. For example, considering SDRAM, then in one example implementation the sideband signal might be provided over the data mask (DQM) signal path, for example by making that path bidirectional so that in the event of a read that path can be used to implement the sideband signal.

Through use of such a sideband signal, this enables the memory controller to decide how to interpret the data provided in each beat of the read data burst. In particular, as mentioned earlier, when the compression scheme is applied to a data burst, metadata is transmitted in a given beat, in one example implementation the given beat being the first beat of the data burst. If the sideband signal indicates that the compression scheme has been applied to the read data burst, then the memory controller knows that that first beat contains metadata, which will include at least the compression indication data identifying each data block in the data burst that is being transmitted in the compressed form. This information in turn enables the memory controller to determine how to interpret any other beats provided as part of the read data burst. Conversely, if the sideband signal indicates that the compression scheme has not been applied, the memory controller can interpret the data in each beat in the standard manner, namely where each beat is used to transmit a corresponding data block of the data burst.

In one example implementation, the above-mentioned sideband signal can also be used to provide additional information. For example, where multiple compression schemes are supported, the sideband signal could be used to identify which compression scheme has been used. Alternatively, information about the form of compression scheme applied could be encoded in the metadata provided in the given (e.g. first) beat of the compressed data burst. The latter approach can be useful in certain situations, for example where it is undesirable to provide a multi-bit sideband signal, and instead it is preferred to use a single bit sideband signal merely to indicate whether compression has been applied or not. The latter approach could also be a more efficient approach to take in situations where a compressed write data burst provided to the memory device is stored within the memory device in the compressed format, rather than being decompressed prior to writing to the memory device. In such a scenario, the form of compression scheme applied will be encoded in the metadata that is stored into the memory device, so that that information moves with the data as it is written into, and subsequently read from, memory. Hence, on reading the compressed data burst from memory, there is no need to re-evaluate that data to determine the form of compression scheme used, since that information will inherently be part of the metadata.

In one example implementation, data may always be stored within the memory device in uncompressed form, irrespective of whether it has been provided over the communication path in either a compressed format or an uncompressed format. However, as noted above, in another example implementation the memory device may support storage of data bursts in a compressed format. Hence, in such an example implementation, the memory device may be configured, when receiving a write data burst from the memory controller in a compressed format as a result of the write data burst having had a compression scheme applied thereto by the memory controller, to store the write data burst in the memory device in the compressed format, and to set an associated state flag in the memory device to identify that the write data burst has been stored in the compressed format. The memory device can then be arranged, when reading data from the memory device to generate a read data burst, to determine whether the associated state flag is set, and when the associated state flag is set, to output the read data burst in the compressed format along with the associated sideband signal to indicate to the memory controller that the compression scheme has been applied.

By supporting storage of data in compressed format in the memory device, there is then no need to decompress data before storage in the memory device, and hence no need in due course to read the data uncompressed, evaluate that data, and if appropriate re-compress that data before outputting it to the memory controller in response to a read command. Instead, all that is required is to mark the data as being compressed when stored in the memory device, and then to signal to the memory controller that the data is compressed when it is subsequently read and returned to the memory controller. As noted earlier, in some instances an indication of the compression type may also be signalled to the memory controller, for example if the information cannot be inferred from the metadata in the given/first beat. Such an approach also saves energy when writing data into, and reading data from, the memory elements of the memory device.

However, in some instances it may be considered beneficial to provide a compression (and corresponding decompression) engine in the memory device, to provide additional flexibility. For instance, without such functionality in the memory device, a compressed burst would be stored in a compressed form in the memory device, and an issue that could then arise is if subsequently a sub-burst write was performed to that compressed region. It would then be necessary for the memory controller to read the compressed data burst, decompress it, update the one or more affected beats with the new data, compress the updated data burst and then write it back to memory. If instead the original compressed data burst had been decompressed so that the data had been stored uncompressed in the memory device, then the subsequent sub-burst write could be performed directly without needing to perform such a read-modify-write sequence. However, depending on the memory technology used, the need for a read-modify-write sequence in such instances may not be as much of an overhead as it at first may appear. For example, SDRAM is designed to transfer bursts of data. Hence, a sub-burst write is not very efficient, and therefore is not common. In addition, the read and the write will be to the same row in the SDRAM, and hence will be performed efficiently.

In one example implementation where the above-mentioned apparatus is a memory device, the apparatus may further be provided with a read queue into which to receive a plurality of read commands from the memory controller. Then, when a read data burst is issued by the apparatus in response to a given read command, the given read command may be removed from the read queue, and the memory device may be configured to begin processing a next read command in the read queue. This approach can provide significant performance improvements in some instances. In particular, the memory controller does not know how compressed the read data will be, and hence cannot determine a suitable separation between adjacent read commands that it wishes to issue to the memory device. However, by providing a read queue into which multiple read commands can be received by the memory device, this effectively decouples the read commands from the associated read data. Once a read command is popped from the queue, this frees up room in the queue for another read command from the memory controller to be accepted into the queue for subsequent processing by the memory device. Such an approach can make better utilisation of the communication path when performing multiple burst read operations by reducing the period of time that the communication path is unused.

Particular examples will now be described with reference to the figures.

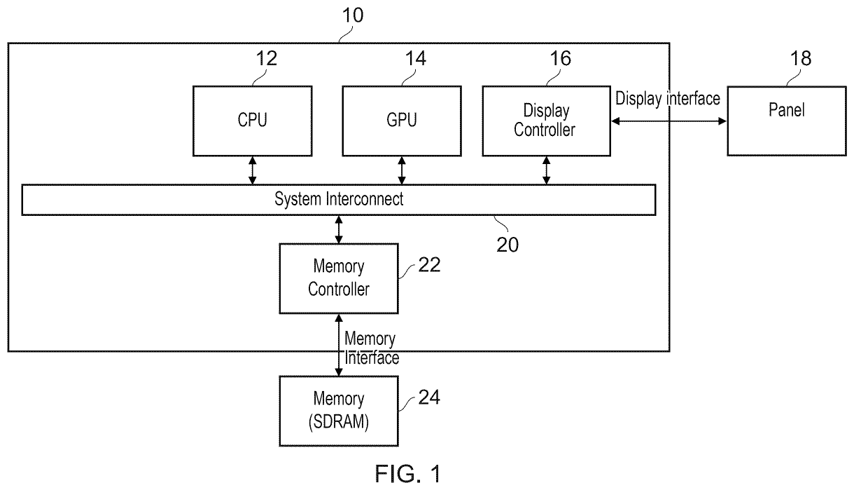

FIG. 1 is a block diagram schematically illustrating a data processing system in which the techniques described herein may be employed. In this example, a system-on-chip 10 comprises a number of processing elements such as a central processing unit (CPU) 12 and a graphics processing unit (GPU) 14 used to perform data processing operations on data accessible in memory 24. The memory can be formed in a variety of ways, but in the example illustrated in FIG. 1 is assumed to consist of one or more synchronous dynamic random access memory (SDRAM) devices. The SDRAM memory could take a variety of forms, for example SDR-SDRAM, DDRx-SDRAM, LPDDRx-SDRAM (low power variant), GDDRx-SDRAM (graphics variant), etc. The processing elements 12, 14 are connected to a system interconnect 20 via which they can be coupled to other components within the system, such as a memory controller 22 used to control access to the memory 24 via a memory interface, and a display controller 16 used to control an associated display panel 18 via a display interface.

It will be appreciated that FIG. 1 is a simplified figure merely showing certain components that will be referred to when describing the techniques discussed herein, and a typical system will include other components not shown. Purely by way of example, the system will typically have one or more levels of cache in which the data in memory can be temporarily stored in order to speed up access to that data by the processing elements 12, 14. Some of those levels of cache may be local to each of the processing elements, while one or more other levels of cache may be shared between processing elements. Further, whilst the components 12, 14, 16, 20 and 22 are shown as residing within a single system-on-chip, with the memory device 24 and display panel 18 external to that system-on chip, this is not a requirement, and exactly how the components are packaged is immaterial to the techniques described herein. For example, whilst the memory device 24 may often be provided on a separate chip to the chip containing the processing elements, other forms of memory may be integrated within the chip that provides the processing elements, for example when the memory takes the form of Stacked DDR-SDRAM. As another example, even when the memory device is provided in a separate piece of silicon to the SoC, the one or more pieces of silicon may be integrated into the same package, resulting in a Multi-Chip-Module.

As will be discussed in more detail herein, irrespective of how the various components are packaged, and irrespective of the actual technology used to implement the memory 24, the techniques described herein may be used to support selective use of compression in connection with data blocks sent as part of a data burst over the memory interface (also referred to herein as the communication path or communication bus) provided between the memory controller 22 and the memory 24.

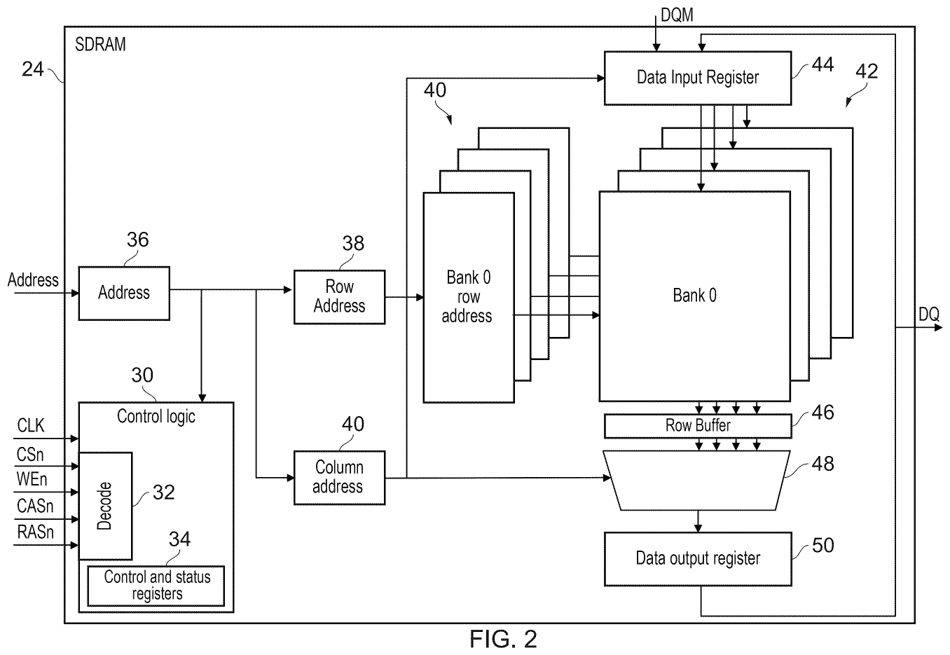

FIG. 2 illustrates in more detail operation of an SDRAM memory device 24. The memory device can be constructed from one or more banks 42 of storage elements, each bank arranged to provide an array of storage locations arranged in rows and columns. Control logic 30 is provided with a number of control and status registers 34 whose values can be programmed in order to control the operation of the memory 24. A variety of control signals may be issued to the control logic 30 along with a clock signal used to control the operation of the memory device, and those various control signals can be decoded by the decode block 32 in order to determine the operations to be performed in response to those control signals. Purely for the purposes of illustration, FIG. 2 illustrates chip select (CSn), write enable (WEn), column address select (CASn) and row address select (RASn) control signals used in DDR1 to DDR4 versions of SDRAM. Dependent on the value of those various control signals, the information 36 provided over the address bus can be used to identify values to be written into one or more of the control and status registers 34, can be used to identify a bank and a row address 38 within that bank when activating a particular row within the identified bank, or can be used to identify a bank and column address 40 when performing write and read operations.

When a row address within a given bank is activated, the contents of that row are written out into a row buffer 46. Thereafter, write and read operations can be performed in respect of the data held in that row buffer. For instance, write data can be provided into the data input register 44 for writing into one or more data value locations within the row buffer 46 in accordance with the column address information. In one example implementation, as the connection between the sense amplifiers forming the row buffer and the corresponding storage locations within the relevant bank may be left open, writes performed to the row buffer may be propagated into the corresponding storage locations of the bank as well. When performing read operations, the column address information can be used to control the multiplexer 48 in order to read out into the data output register 50 the data value stored in one or more of the storage locations of the row buffer 46.

Multiple read/write operations may be performed within the same active row, before the row is closed using a precharge command to close the connection between the row buffer 46 and the active row within the relevant bank, this process ensuring that the storage locations of the active row have been updated to reflect any writes to the row buffer 46, and resetting the row buffer ready for another row to be selected as the active row.

Whilst in FIG. 2, only one instance of the data input register 44, row buffer 46, multiplexer 48 and data output register 50 are shown, separate instances of those components can be provided in respect of each of the banks, and the memory device may be configured to allow a row to be opened simultaneously in each bank.

From the above description, it will be appreciated that the activated row comprises a sequence of data values occupying a given address range, and those data values are then stored within the row buffer 46 to allow write and read accesses to be performed in respect of those data values. Often the write and read operations are performed as data bursts comprising a plurality of data blocks associated with a sequence of addresses within the given address range. A data burst may be processed by sending over the memory interface each data block in a separate beat, with the memory interface typically having a bus width sufficient to handle the transmission of a data block in each beat and being operated at a higher frequency than the speed at which memory elements in the memory can be accessed. The discrepancy in the speed with which the memory interface can be operated and the speed with which memory elements can be accessed is managed by virtue of accessing the memory elements as entire rows, bringing the contents of the entire row into the row buffer. A data burst can then be associated with a sequence of addresses within the activated row, causing each of the addresses in that sequence to be written to with an updated data value (in the event of a write data burst) or each address in the sequence to have its data value read (in the event of a read data burst). In one example implementation, one or more of the control registers 34 is set to identify certain parameters associated with data bursts, such as the burst length (i.e. the number of data blocks within a data burst), and whether the sequence of addresses to be accessed are a sequential sequence of addresses or are a sequence of addresses following a specific defined pattern (in either case a start address will typically be specified as an address 36 to identify the start of the sequence of addresses).

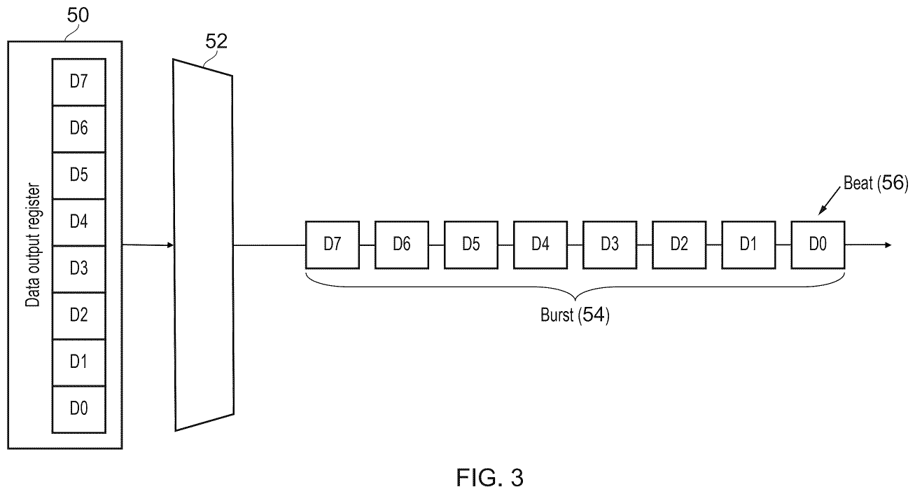

As illustrated in FIG. 3, it will hence be appreciated that when considering a read data burst, a read access may be performed using the multiplexer 48 to read into the data output register 50 a sequence of data values. In the example shown in FIG. 3, it is assumed that the sequence of data values is a sequence of eight data values, and for the purposes of illustration it will be assumed that those data values are associated with a consecutive sequence of addresses. Those data values are then output over the memory interface to the memory controller, via the multiplexer 52, as a burst 54 comprising a sequence of eight beats 56. Each beat will identify one of the data values within the burst, and one or more beats may be sent per clock cycle depending on implementation (for example in DDR memory two beats will be transferred in each clock cycle, one on the high part of the clock cycle and one on the low part of the clock cycle). It will be appreciated that a similar mechanism can be used when providing a write data burst, with the memory controller sending a separate data value in each beat of the burst over the memory interface from the memory controller to the memory device, where those data values can be received into the data input register 44 for subsequently writing into the row buffer 46 and the activated row of the relevant bank.

In accordance with the techniques described herein an apparatus is provided that is able to issue data bursts comprising multiple data blocks over a communication path to a recipient device, and which can selectively choose to apply a compression scheme to a given data burst in order to cause one or more data blocks of the given data burst to be represented in a compressed form when transmitted over the communication path. This can lead to an increase in the effective available bandwidth over the communication path by reducing the number of beats required to transmit a data burst to which the compression scheme has been applied. It can also enable a reduction in power consumption associated with communications between the apparatus and the recipient device. Whilst the apparatus can take a variety of forms, in one example implementation the apparatus may take the form of a memory controller used to communicate with a memory device over a communication path providing a memory interface. The compression mechanism described herein can be adopted within the memory controller in respect of write data bursts issued to the memory device, and if desired the memory device itself may also support use of the compression mechanism in order to compress read data bursts prior to transmission back to the memory controller. In addition, or alternatively, the memory device may be able to store a received write data burst within the storage elements of the memory device in the compressed format provided, with that compressed format then being maintained when the data is subsequently read out of the memory device and provided back over the memory interface as a read data burst to the memory controller.

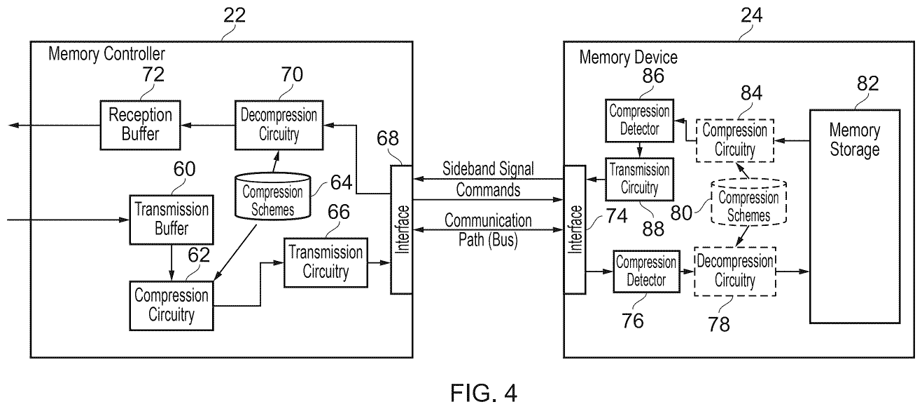

FIG. 4 is a block diagram illustrating components that may be provided within the memory controller 22 and the memory device 24 to support the compression mechanism described herein, in accordance with one example implementation. As shown in FIG. 4, data to be written to the memory device 24 may be received into a transmission buffer 60 of the memory controller 22. It should be noted that data may be sent in bursts over the system interconnect 20 to the memory controller 22, and those bursts could be very large and hence could potentially overlap multiple SDRAM rows. In one example implementation, such a long data burst from the interconnect can be broken up into SDRAM row bursts for storing within the transmission buffer 60 for subsequent transmission to the memory device 24. Hence, the write data can be organised into write data bursts within the transmission buffer, where each data burst comprises a plurality of data blocks associated with a sequence of addresses within a given address range, such as a consecutive sequence of addresses within an address range associated with an activated row within a bank of the memory device (as noted earlier when discussing FIG. 2, the contents of such an activated row are typically stored into an associated row buffer for the bank in question, whereafter data values within that row can then be accessed in order to write data to a sequence of addresses within that row or to read data from a sequence of addresses within that row).

The compression circuitry 62 can be arranged to select a data burst from the transmission buffer 60, and then to evaluate whether to apply a compression scheme to that selected data burst. In some implementations there may be a single compression scheme considered by the compression circuitry, and the compression circuitry may evaluate whether applying the compression scheme to the selected data burst would be appropriate, having regard to the data values of each data block within that data burst. For example, it may decide only to apply the compression scheme if as a result of applying the compression scheme the total number of beats required to transmit the data burst is reduced by at least a predetermined percentage. However, in other implementations there may be a variety of compression schemes 64 available to the compression circuitry, and the compression circuitry may be arranged to consider all of those compression schemes to decide which compression scheme would achieve the best compression result having regard to the data values being considered, or may be arranged to select a subset of the available compression schemes taking into account certain criteria, with that selected subset of compression schemes then being considered in order to determine which compression scheme in the subset would achieve the best compression result. Thereafter, based on the compression scheme or schemes considered, it is then decided whether to apply compression or not to the selected data burst. Various factors may be taken into account by the compression circuitry when deciding on a subset of compression schemes to consider, for example the compression schemes supported by the memory device, the type of data included in the data burst under consideration, which may for example be dependent on the workload being performed by one or more processing elements within the system that has resulted in the data burst being generated, etc.

Once the compression circuitry 62 has decided whether to apply a compression scheme to the selected data burst or not, and has applied that compression scheme if a decision was taken to use it, then the transmission circuitry 66 is used to transmit the data burst (in either its uncompressed format or its compressed format depending on the decision taken by the compression circuitry) via the interface 68 over a communication path of the memory interface to the interface 74 within the memory device 24. In association with that transmission, a command will be issued over the memory interface to the memory device to identify the type of operation being performed. In one example implementation, for a write data burst, the corresponding write command may be configured to identify whether the data burst being transmitted is in uncompressed format or compressed format. For example, one form of the command may be used for transmission of uncompressed data bursts and another form of the command may be used for transmission of compressed data bursts.

When the compression circuitry 62 has not applied the compression scheme to the selected data burst, then the transmission circuitry 66 is arranged to transmit the selected data burst as a series of N beats over the communication path, where each beat is used to transmit a corresponding data block. However, if instead the compression circuitry has applied the compression scheme to the selected data burst, the transmission circuitry 66 is configured to transmit the selected data burst by transmitting over the communication path, in a given beat (for the purposes of the following discussion it will be assumed that this is the first beat), metadata that comprises at least compression indication data to identify each data block of the given data burst that is in the compressed form. Further, any uncompressed data blocks of the selected data burst are transmitted in one or more further beats. Depending on the compression scheme utilised, then it may also be necessary to transmit, in one or more additional beats, supplementary information required to enable the memory device to determine the data value of each data block that is in the compressed form. This will be discussed in more detail later with reference to the various examples of compression scheme described later herein.

Where more than one compression scheme is supported, then the command sent from the memory controller to the memory device may identify the form of compression scheme used when compression has been applied, or alternatively that information can be included in the above-mentioned metadata sent in the first beat along with the compression indication data identifying the data blocks that have been subjected to compression.

Within the memory device 24, the compression detector 76 can be arranged to identify whether the received data burst is in a compressed format or not. As will be apparent from the above discussion, this may be deduced with reference to the associated command that was transmitted with the data burst. In one example implementation, the received data burst can then be stored within the memory storage 82 in the format it is received in, whether that be uncompressed or compressed, with additional state being stored in the memory device in association with the data burst to identify whether the data burst is in the compressed format or not. Alternatively, the decompression circuitry 78 can be used to decompress the received data burst in the event that it has been received in a compressed format, with reference to stored compression scheme information 80. In the event that more than one compression scheme is supported, then it will be apparent from the earlier discussion that information about the compression scheme applied can be determined from the information transmitted to the memory device 24 (whether that be included within the command information, or within the metadata transmitted in the first beat), hence allowing the correct decompression of the data burst. Thereafter, the uncompressed data burst may be stored within the memory storage 82.

Considering a read data burst, then a read command may be issued from the memory controller 22 to the memory device 24, causing multiple blocks of data to be read from the memory storage 82 to form the read data burst. Where compression functionality is provided within the memory device 24, then compression circuitry 84 may be provided that operates in much the same way as the compression circuitry 62 discussed earlier with reference to the memory controller 22. Hence, it may selectively choose to compress an uncompressed data burst received from the memory storage, prior to the transmission circuitry 88 in the memory device then outputting the compressed read data burst to the memory controller 22 over the communication path of the memory interface. The compression detector 86 can determine, based on the output from the compression circuitry, whether compression has been applied not, so that that information can be included in association with the data burst sent over the communication path. In one example implementation, a sideband signal can be provided for this purpose to enable the memory controller to be informed as to whether the read data burst it is receiving is an uncompressed data burst or a compressed data burst.

In implementations where the write data received from the memory controller for storage in the memory storage 82 of the memory device 24 is stored in the form it is received in, and hence is stored in compressed format if it is received in compressed format, then there may be no need for the compression circuitry 84, and instead the compression detector 86 may merely determine, from the earlier-mentioned additional state stored in association with the read data burst, whether that read data burst is in compressed format or not so that the appropriate sideband signal can be set by the transmission circuitry 88 when the read data burst is output over the communication path.

As shown in FIG. 4, the memory controller 22 may include decompression circuitry 70 that, responsive to receiving a read data burst that is in compressed format, can be arranged to decompress the data burst prior to storing the uncompressed data burst within reception buffer 72, from where it can be propagated over the interconnect 20 (as shown earlier in FIG. 1) to the relevant processing element that has requested that data. Whilst in FIG. 1 the transmission buffer 60 and the reception buffer 72 are shown as separate buffers, in another example implementation the transmission and reception buffers may be unified into a single buffer structure.

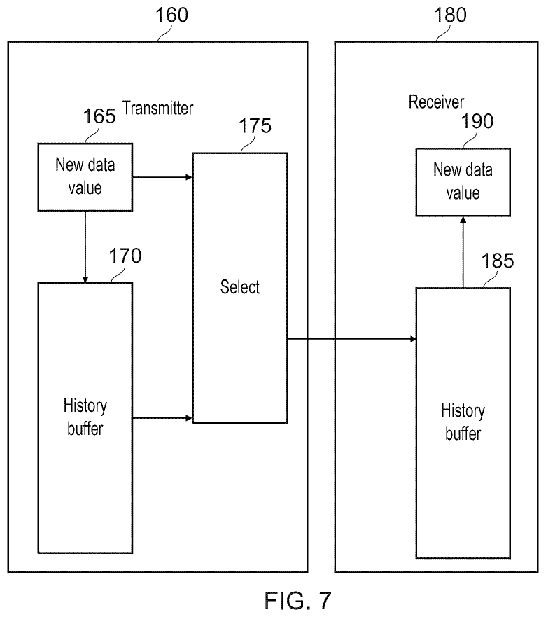

In one example implementation, the compression circuitry 62 may be arranged to selectively reorder write data bursts in the transmission buffer if it determines that such a reordering would enable an improvement in the compression efficiency achieved when transmitting those data bursts over the communication path of the memory interface. As a result of performing such reordering, this can hence improve the bandwidth of the communication path. For example, if it is determined that a first pending data burst contains data of a similar type to a third pending data burst, but different to the data type of the second pending data burst, and there is an expectation that the data values in the first and third pending data bursts may hence be similar, it may be beneficial to schedule the third pending data burst after the first pending data burst, and before the second pending data burst, as that may give rise to improved compression when adopting certain compression schemes, for example when adopting the history buffer based compression scheme that will be discussed later with reference to FIGS. 7 to 12.

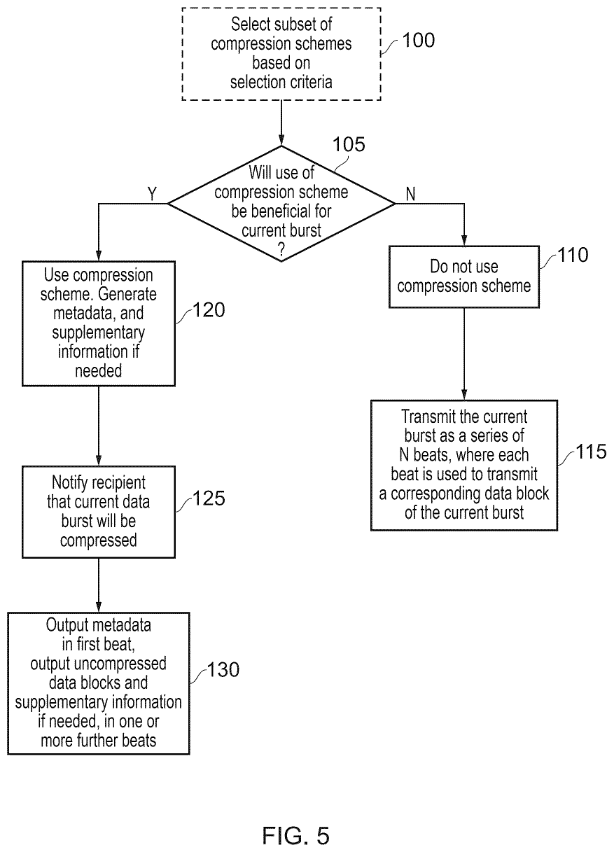

FIG. 5 is a flow diagram illustrating steps performed when evaluating a data burst for transmission over the communication path from the memory controller 22 to the memory device 24, or indeed from the memory device 24 to the memory controller 22 in the event that the memory device is provided with its own compression circuitry 84. At step 100, if more than one compression scheme is supported within the system, then optionally a step 100 may be performed to select a subset of the possible compression schemes based on predefined selection criteria. As will be apparent from the earlier discussions, those criteria may for example take into account factors such as the compression schemes supported by the recipient, the type of data contained within the data burst, which itself may depend on the workload being performed by the processing element that is processing that data, etc.

At step 105, it is then determined whether use of a compression scheme will be beneficial for the current data burst under consideration. Where just a single compression scheme is considered, this may involve evaluating whether use of the compression scheme will give rise to a predetermined reduction in the number of beats required to transmit the data burst, relative to transmission of the data burst in uncompressed format. Where multiple compression schemes are being considered, this process may involve deciding which of the compression schemes will give the best compression benefit, and then assessing whether that compression scheme will give rise to the above-mentioned predetermined reduction in the number of beats required to transmit the data burst.

If it is decided that use of a compression scheme will not be beneficial, then the process proceeds to step 110 where a compression scheme is not used, and instead at step 115 the current data burst is transmitted as a series of N beats, where each beat is used to transmit a corresponding data block of the current burst (it being assumed in this example that the data burst comprises N data blocks).

However, if it is decided to use a compression scheme, then that compression scheme will be applied at step 120, as a result of which metadata will be generated as discussed earlier, to identify at least each data block of the data burst that is to be transmitted in a compressed form. If needed, certain supplementary information may also be generated to enable the recipient device to determine the data value of each data block that is in the compressed form.

At step 125, the recipient is then notified that the current data burst will be compressed. As discussed earlier, this can for example be signalled by the use of different variants of command sent over the memory interface when considering a write data burst sent from the memory controller 22 to the memory device 24, or in the example of a read data burst may be signalled via use of an appropriate sideband signal sent from the memory device 24 to the memory controller 22 in association with the read data burst.

At step 130, the above-mentioned metadata is then sent in a first beat, and any uncompressed data blocks are output in one or more further beats, as is the above-mentioned supplementary information if that is needed.

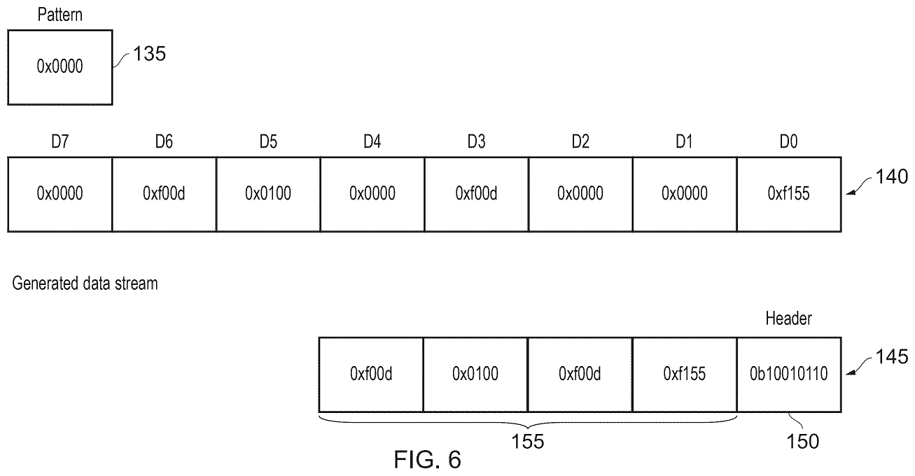

FIG. 6 illustrates, by way of specific example, one form of compression scheme that may be used in an example implementation. In particular, an uncompressed data burst 140 comprising eight data blocks is shown, each of the data blocks having the specific data values illustrated in FIG. 6. As also shown, a predefined data value pattern 135 is set in the transmitting apparatus, and also notified to the recipient device. Considering the example where the memory device 24 is a recipient device and the memory controller 22 is the transmitting apparatus, then the pattern 135 may be stored within one of the control registers 34 of the memory device via issuing of a suitable control register setting command at some point prior to the data burst being transmitted.

As shown in the lower part of FIG. 6, a compressed format 145 of the data burst can be generated by compression circuitry, where in a first data beat 150 (or a portion of that first beat) a header portion is specified comprising metadata used when reconstructing the uncompressed form 140 of the data burst. The metadata can comprise a number of pieces of information, but one of the pieces of information provided is compression indication data which takes the form shown within the first data beat 150 of FIG. 6. In this example, a logic zero value in the compression indication data indicates that the corresponding data block is transmitted in uncompressed form, whilst a logic one value indicates that the corresponding data block has the value given by the pattern 135, which in this specific example is an all zero data value. As shown in FIG. 6, any uncompressed data blocks can be transmitted in a number of further beats 155 following the first beat 150 containing the header. Such a compression scheme can provide significant compression benefits, particularly when a significant number of the data blocks has a predetermined data value, such as an all zero value. This can occur often in practice, for example when clearing regions of memory, e.g. C library function calloc( ), or when handling Machine Learning data. Whilst in FIG. 6 a single pattern 135 is predefined, in alternative implementations more than one pattern could be predefined, for example by setting different values in a number of the control registers of the memory device. By way of specific example, an all zero pattern and in all one pattern could be specified. Such an approach may for example be useful when handling small signed numbers.

As another example of a compression scheme that may be utilised, a compression scheme making use of a data history buffer may be employed. Such a is illustrated schematically by the block diagram of FIG. 7. In particular, the transmitter 160 has a data history buffer 170 accessible to its compression circuitry, and used to store one or more data values output to the recipient/receiver device 180 over the communication path. The recipient device 180 is then arranged to reconstruct the data history buffer content in its own copy of the data history buffer 185, based on the data values that it receives over the communication path. As each new data value 165 within a data burst is considered by the transmitter, it is determined whether that data value is already present within the history buffer 170, and if so an identifier of the entry in the history buffer containing the data value is selected by the selection circuitry 175 for transmission to the receiver device 180. If the data value is not already present in the history buffer, then the data value itself is selected by the selection circuitry 175 for sending to the receiver device, and in one example implementation that data value is also added to the data history buffer 170. The receiving device 180 is arranged to apply the same rules when deciding when to add data values to its version of the history buffer 185, so as to keep the content of the history buffer 170 and the content of the history buffer 185 aligned.

Whilst the way in which the data values are maintained within the history buffer may vary dependent on implementation, in one specific example implementation, the following rules are applied. As noted above, if a data value is already in the history buffer, the entry in the history buffer containing that data value can be sent to the receiver device, for example by transmitting an index value identifying the buffer entry. Also, in one example implementation, on occurrence of such a hit on a value in the history buffer, that data value is moved to the top of the history buffer, and hence thereafter identified by an index of zero (i.e. 0x0). The other data values in the history buffer are moved down the buffer. If for a data value under consideration, there is a miss in the data history buffer (i.e. that data value is not already present in an entry of the data history buffer), then that data value is transmitted to the receiver as noted earlier, and in addition that data value is added to the top of the history buffer, with the other data values then being shifted down the buffer. The receiver device also applies the same rules so as to update its history buffer contents 185. Whilst in the above description data values are described as being added to the top of the history buffer, with other data values shifted down the buffer, it will be appreciated that the exact mechanism used to index into the history buffer may be varied dependent on implementation, and with the use of appropriate pointers the above shifting of data values relative to the top of the history buffer can be achieved without needing to physically move data values between different storage elements within the buffer, if desired.

As shown in FIG. 7, by updating the history buffer contents 185 using the same rules as are used to update the history buffer contents 170 in the transmitter, then when an index value for the history buffer is provided by the transmitter 160, a lookup in the history buffer 185 can be performed by the recipient 180 in order to obtain the associated data value to provide as the new data value 190, and when an uncompressed data value is provided by the transmitter 160, the history buffer 185 can be updated and the uncompressed data value provided as the new data value 190.

As will be apparent from the earlier discussion of FIG. 4, whilst the memory controller may be the transmitter 160 and the memory device 24 may be the receiver, it is also possible, dependent on implementation, that the memory device 24 may form the transmitter and the memory controller 22 may form the receiver. Whilst separate history buffers could be maintained for write data bursts from the memory controller to the memory device and for read data burst from the memory device to the memory controller, in one example implementation the history buffers 170, 185 could be shared for both write data burst and read data bursts.

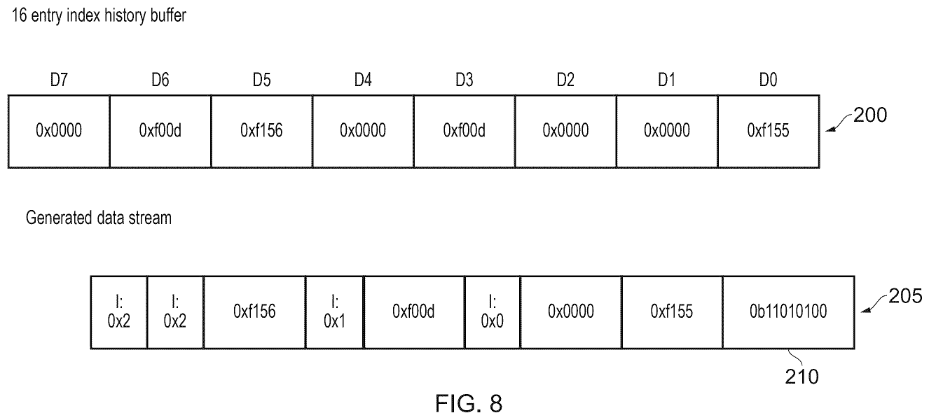

FIG. 8 illustrates, by way of specific example, the above described history buffer based compression scheme that could be used in one example implementation. As shown in the upper part of FIG. 8, an uncompressed data burst 200 comprising eight data blocks having the values shown may be considered for transmission. The number of entries in the history buffer may vary dependent on implementation, but it is assumed in the example of FIG. 8 that a 16 entry history buffer is provided. The compression circuitry performs compression in order to generate the compressed data stream 205 where the first beat 210 includes metadata, and in particular the earlier-mentioned compression indication data used to identify each data block within the data burst that is in the compressed form. Hence, in this example, that compression indication data identifies for which data blocks an index into the history buffer is provided rather than the uncompressed data value. When adopting the earlier described rules for updating the history buffer, it will be appreciated that for the sequence of data blocks 200, the third, fifth, seventh and eighth data blocks can be transmitted by reference to an index in the history buffer, and the index values will be those shown in FIG. 8 within the compressed data burst 205.

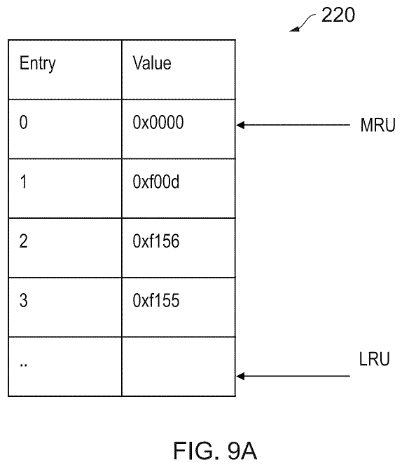

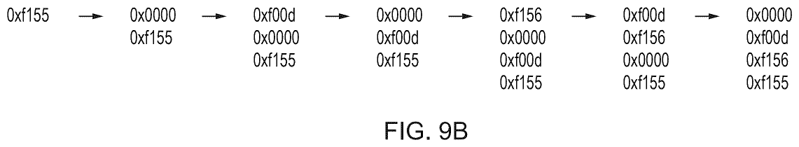

As shown in FIG. 9A, by the time all of the data blocks of the data burst have been processed, the history buffer may take the form 220 shown in FIG. 9A, with FIG. 9B showing the sequence of updates to the history buffer during the processing of the data burst 200 due to application of the above described update rules.

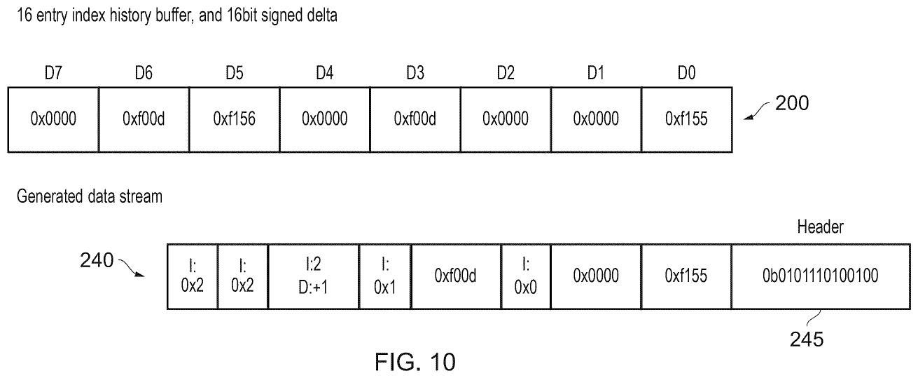

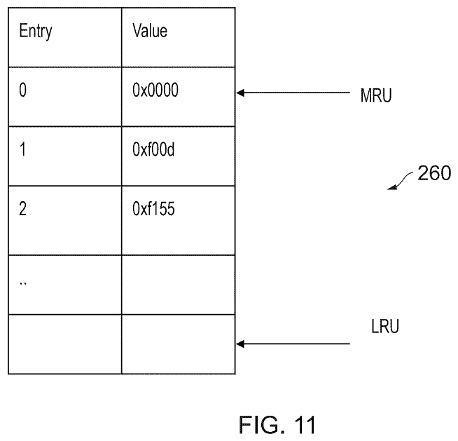

Whilst the above history buffer based compression scheme is, in one example implementation, only used for a data value that actually matches a stored data value in an entry of the data history buffer, in another example implementation the scheme can be extended to also enable compression in respect of data values that are close to data values stored in the data history buffer. This approach is illustrated schematically in FIG. 10. As with the earlier described FIG. 8, it is assumed that a 16 entry history buffer is used, but also that a 16-bit delta value can be specified to indicate an offset (for instance a signed offset) relative to a value stored in the history buffer. In accordance with this modification, when starting with the same uncompressed data burst 200, the compressed version 240 that may be produced takes the form shown in FIG. 10. In this case, it can be seen that the uncompressed data value 0xf156 no longer needs to be transmitted, since it can be identified in a compressed form by reference to the entry of the buffer storing the value 0xf155 and also specifying an offset of +1. When assessing that the data value 0xf156 can be represented in this way, the data value referenced (in this case 0xf155) is moved to the top of the buffer, becoming the most recently used entry, but the delta value itself is not added to the history buffer. In accordance with this modified implementation, the header indicates which data blocks are derivable from data values stored within entries of the history buffer. If a bit is set high, then the following bit indicates if there is an associated delta offset or not, with a logic zero value indicating that there is no delta offset, and a logic one value indicating that there is a delta offset. When taking this approach, it will be appreciated that the compression indication data takes the form shown within the header portion 245 of the compressed data burst 240. As shown in FIG. 11, by the time all of the data blocks of the data burst have been processed, the history buffer may take the form 260 shown in FIG. 11.

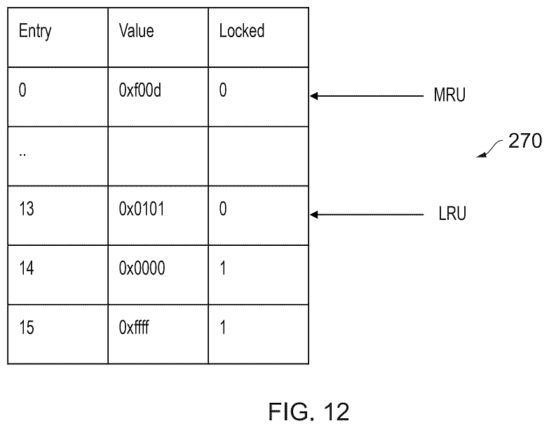

As shown schematically by the example of a history buffer 270 shown in FIG. 12, certain data values can be locked into the history buffer in the transmitter, and identified so as to be treated in the same way in the history buffer of the receiver. For example when the receiver is the memory device, a command could be issued to set one or more control registers to identify one or more values that should be locked within the history buffer. The example in FIG. 12 shows a 16 entry history buffer, with the values in entries 14 and 15 locked. In particular, entry 14 stores an all zero value and entry 15 stores an all one value. By taking such an approach, this means that the first time such a value is encountered, it can be treated as having hit in the history buffer, rather than the first occurrence being treated as a miss. With regard to a locked value, when that locked value is encountered, that value can then be moved to the most recently used entry in the same way as discussed earlier, or alternatively could be left in its current entry position. Hence, by way of example, if the value 0x0000 is encountered this would result in a hit, and the value 0x0000 could either be retained in entry 14, or promoted to entry 0 (in either case the entry containing value 0x0000 being marked as locked). Whatever approach is taken, it should be noted that when all of the entries in the history buffer are full, an entry containing a locked value is not chosen for eviction, and instead a value in one of the other entries is chosen.

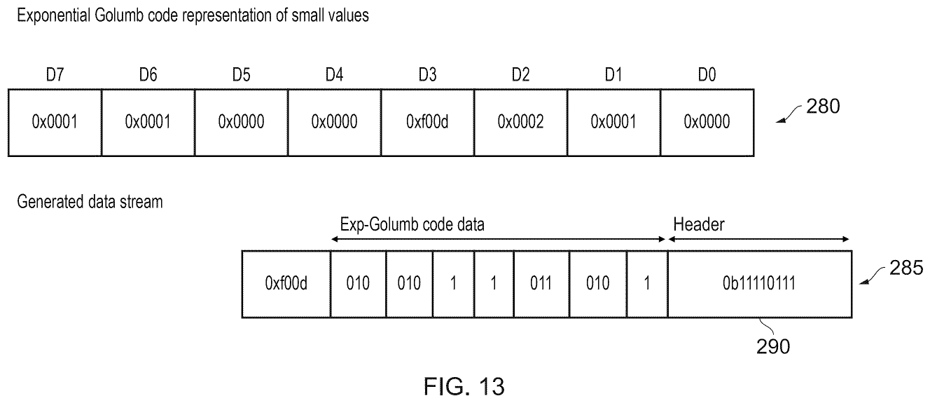

FIG. 13 schematically illustrates another form of compression scheme that may be utilised. In this case, the uncompressed data burst is considered to take the form 280. In accordance with this scheme, a Golomb coding scheme is used, in particular an exponential Golomb code scheme, which can be an efficient mechanism for representing small values. In some instances it may be possible for the entire data burst to be written as small values using such exponential Golomb coding, or instead, as shown in the example of FIG. 13, specified values within the burst may use exponential Golomb coding. In this example, the compression indication data within the header portion 290 of the compressed format 285 identifies which data blocks are represented by an exponential Golomb code and which are not. In particular, a logic one value indicates that the corresponding data block is represented by an exponential Golomb code whilst a logic zero value indicates that the corresponding data block is transmitted in uncompressed form. As shown in the example, only the data value in the data block D3 needs to be transmitted in uncompressed form, and each of the other data values can be represented by an exponential Golomb code. Due to the nature of exponential Golomb codes, the receiver is able to determine where one exponential Golomb code ends and the next exponential Golomb code begins.

In a yet further alternative implementation, for example where the data is signed, and there are a mix of small positive and negative numbers, then a signed Golomb coding scheme may be used.

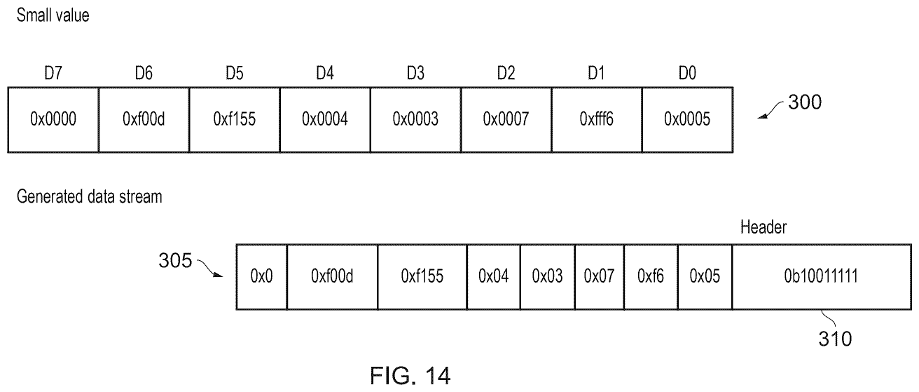

FIG. 14 illustrates a yet further form of compression scheme that may be used, which like the preceding scheme of FIG. 13 can be particularly useful when dealing with small numbers. In this case, whenever a small value is encountered, it is represented as a four bit small value (in this case representing the values +7 to −8, although in an alternative implementation unsigned forms of small values could be supported in a similar way). Hence, when considering the uncompressed data burst 300 this can be represented in the compressed format 305, where the header portion 310 contains compression indication data to identify which data blocks have been represented by small values. A logic one value indicates when the corresponding data block has been represented as a small value, whilst a logic zero value indicates when the corresponding data block is provided in uncompressed form. As can be seen, in this example six of the eight data blocks can be represented in a compressed form.

Irrespective of which compression scheme is used, then in some instances the compression circuitry may be arranged, for each data block, to apply the compression scheme independently to the data bits in different subsets of the data block. By way of example, if it is known that each data block consists of multiple distinct sub-elements (as for example is the case when the data in each data block provides RGB data), then it can be beneficial to apply the compression scheme independently to each of the sub-elements in the data block as this can enable a significant improvement in compression efficiency in certain situations, for example where similar data values in respect of each sub-element are expected across multiple data blocks. As another example, it may be the case that the memory system is constructed of multiple separate memory devices, with different portions of the communication path/bus connecting to different memory devices. In such instances, it may be known that different portions of the communication path are likely to carry data exhibiting different properties, and hence it can be appropriate to apply a compression scheme independently to one or more of those portions.

When considering an implementation where the memory device is a recipient for a number of write data bursts, a row of data in an SDRAM bank may comprise multiple data bursts, with each data burst comprising multiple data blocks. When a given data burst is subjected to a compression scheme, resulting in one or more of the data blocks in that data burst being represented in a compressed form, it will be understood that the amount of storage space required to store the resultant compressed data burst will be less than the amount of storage space required to store the data burst in uncompressed form. In one example implementation, a compressed data burst sent to the SDRAM memory may be decompressed internally by the SDRAM memory, with the decompressed data written to memory. Then, when the data is subsequently read, it may again be subjected to compression prior to outputting that data back to the memory controller.

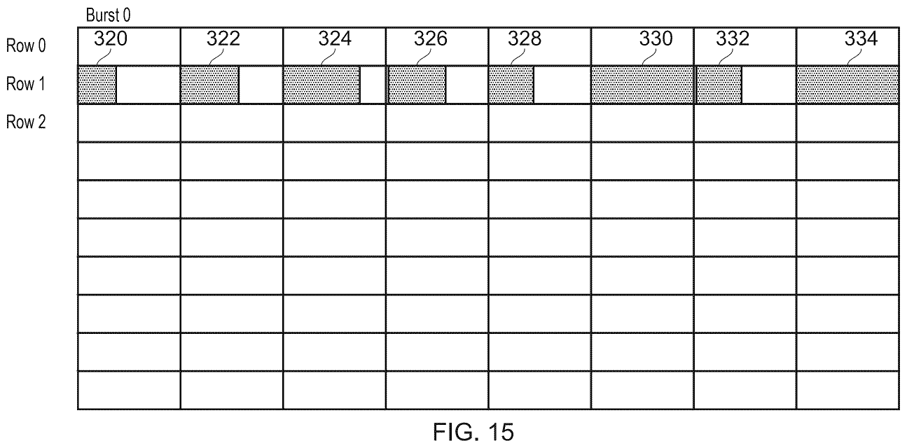

However, in an alternative implementation schematically illustrated by FIG. 15, the data may not be decompressed before it is stored into the SDRAM memory, and instead if a write data burst is provided in compressed format, it may be written directly in that compressed format into the relevant location in memory. In the example shown in FIG. 15, it is assumed that eight data bursts fit within a row of the SDRAM memory, with six of those bursts 320, 322, 324, 326, 328, 332 being stored in a compressed format and two of those bursts 330, 334 being stored in uncompressed format. Such an approach can save power as only part of the SDRAM memory needs to be written, and on a read the data does not need to be recompressed. However, for each burst it is necessary to identify whether that burst has been stored in compressed format, for example by adding an extra state bit to record that information. When the data is subsequently read, the state bit can be used to set a sideband signal to indicate to the memory controller whether the associated data burst is being provided in compressed format, and this can be used by the memory controller to decide how to interpret the various beats of data provided. In particular, as will be apparent from the earlier discussions, when the compressed format is used, the first beat will contain metadata, and in particular the compression indication data used to identify each data block of that data burst that is in the compressed form.

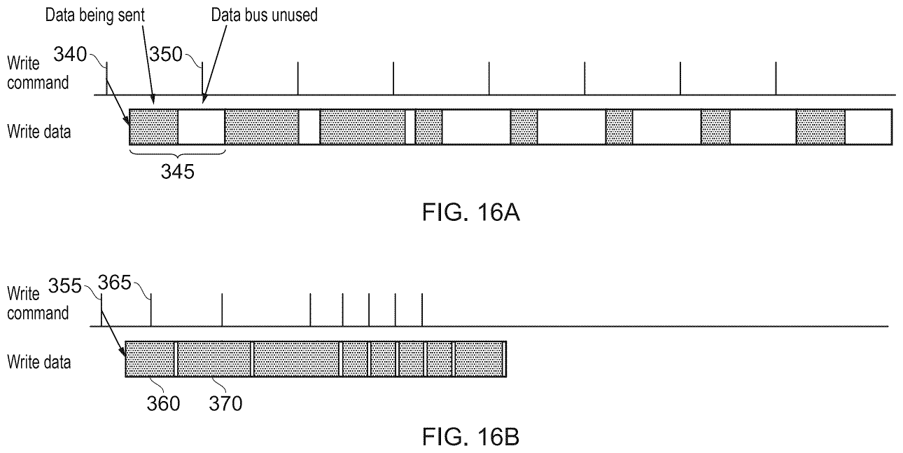

FIG. 16A shows a sequence of write commands and the associated write data bursts transmitted over the memory interface between the memory controller and memory device. As shown in FIG. 16A, the timing between write commands such as the write commands 340, 350 may be set based on an understanding of the number of beats required to transmit a data burst in uncompressed format. However, when a given data burst is compressed, less beats will be required to transmit the data. Hence, considering the write command 340, it is assumed that the time period 345 will be required to transmit the corresponding data burst in uncompressed form. However, as shown, the data is compressed to an extent that only approximately half of that period is required to send the data, with the data bus being unused for the rest of the period. This saves energy, but does not reduce the time taken to send a sequence of data bursts, and does not make best use of the available bandwidth resulting from application of compression.

However, as shown in FIG. 16B, since the memory controller will know the extent to which it has been able to compress the data for a given data beats, it can use that information to control the timing of a subsequent write command. Hence, when considering the write command 355, which gave rise to the compressed write data burst 360, the memory controller can use knowledge of the extent of compression achieved to bring forward the timing of the next write command 365, so as to start transmitting the corresponding write data burst 370 for that write command at an earlier point in time so as to make better use of the data bus. In particular, as shown schematically in FIG. 16B, by appropriate timing of the write commands, the data bus can essentially be fully utilised, thereby increasing the available bandwidth and increasing throughput.

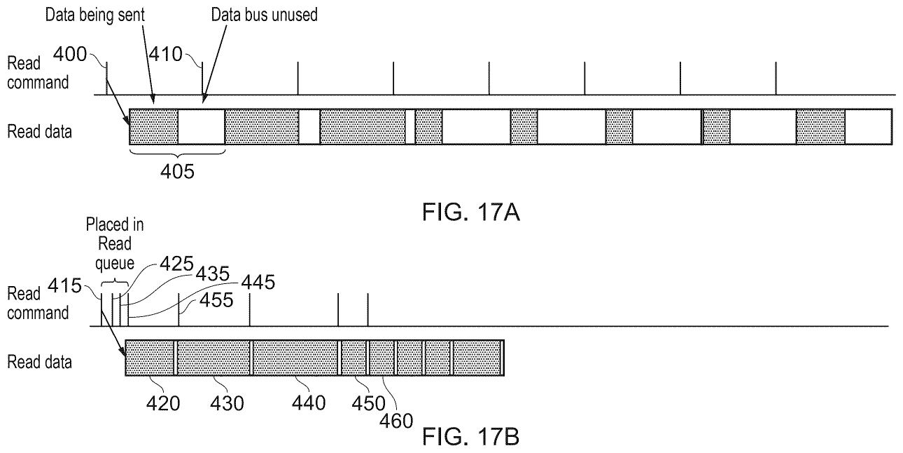

FIG. 17A illustrates essentially the same point as discussed earlier in FIG. 16A, but for read commands and associated read data bursts. As shown in FIG. 17A, the timing between read commands such as the read commands 400, 410 may be set based on an understanding of the number of beats 405 required to transmit a read data burst in uncompressed format. However, as shown schematically in FIG. 17A, only a reduced number of beats is required to actually transmit the read data burst associated with the first read command 400 due to the application of compression, and the data bus is unused for the remainder of the period 405. As with the earlier discussion of FIG. 16A in respect of write data bursts, the compression hence saves energy, but does not reduce the time taken to send a sequence of read data bursts.

Whilst the memory controller issues read commands, it does not perform any resultant compression of the corresponding read data bursts, and hence does not know when the next read command could be issued taking into account the degree of compression achieved. However, in accordance with one example implementation, a read queue may be provided within the memory device to enable multiple pending read commands to be received into the read queue, hence effectively decoupling the read commands from the associated read data. Thus, as shown in FIG. 17B, in that example the read queue may be sufficient to store four pending read commands 415, 425, 435, 445. When the read command 415 is processed and the corresponding compressed read data 420 is generated, the read command 415 can be popped from the queue enabling another read command 455 to at that point be received from the memory controller into the read queue. Further, the memory device can start processing the next read command 425 in the queue with the aim of being able to output the corresponding read data burst 430 as soon as possible after the transmission of the earlier read data burst 420 has been sent.

In addition to the techniques described above, in another example implementation, the read and write commands and the read and write data may both be decoupled from each other if desired.

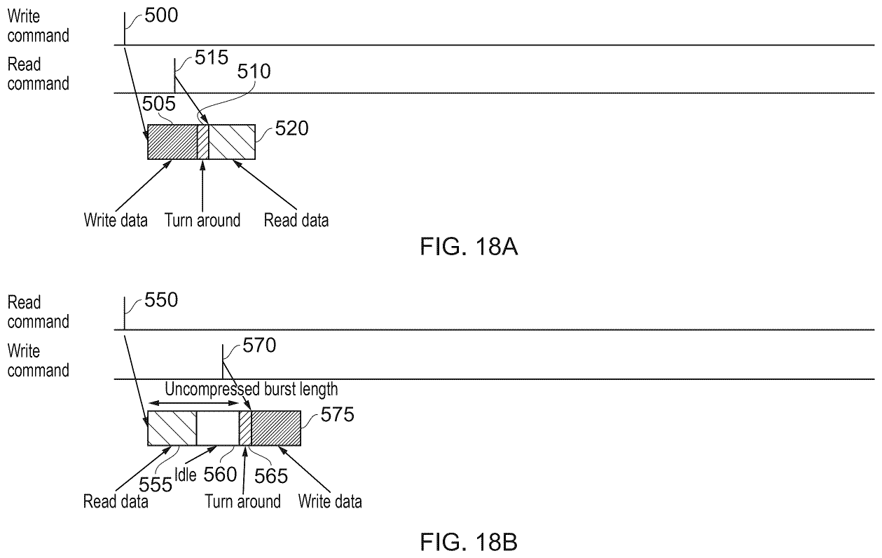

In one example implementation, the same data bus is used to transfer write data from the memory controller to the memory device, and read data from the memory device to the memory controller. Some bus turnaround time is required when switching the bus direction, i.e. to switch from a write to a read or to switch from a read to a write. On transition of a write to a read the memory controller will know how compressed the write data is, and therefore can schedule the read command so that the data bus is fully utilised, ignoring the turnaround period, as illustrated schematically in FIG. 18A. In particular, it can be seen that the timing of the read command 515 following the write command 500 can take into account the size of the write data burst 505 produced as a result of the write command 500, thereby allowing the read data burst 520 to be generated and output on the data bus as closely as possible following the completion of the transmission of the write data burst 505, in particular following the required turnaround time 510 shown in FIG. 18A.

However, such an approach is not available on a transition from a read to a write, since the memory controller will not know the degree to which the read data burst can be compressed. Accordingly, the memory controller will instead schedule the write command timing taking into account the period required to transmit a read data burst in uncompressed form, or when it determines that the read data burst has been sent. This is illustrated schematically in FIG. 18B, where the write command 570 is scheduled at a time after the read command 550 that takes into account the uncompressed burst length for a read data burst. The read data 555 actually only occupies part of that period, with the bus being idle for the remainder of the period 560. Following the turnaround time 565, the write data burst 575 can then be issued in response to the write command 570.

Concepts described herein may be embodied in a system comprising at least one packaged chip. The apparatus described earlier is implemented in the at least one packaged chip (either being implemented in one specific chip of the system, or distributed over more than one packaged chip). The at least one packaged chip is assembled on a board with at least one system component. A chip-containing product may comprise the system assembled on a further board with at least one other product component. The system or the chip-containing product may be assembled into a housing or onto a structural support (such as a frame or blade).

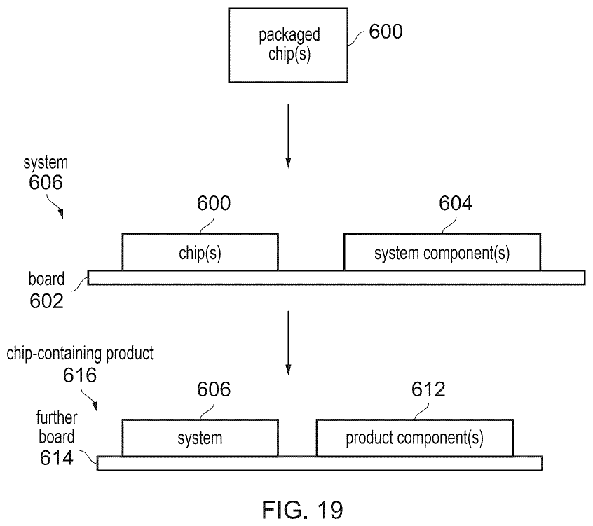

As shown in FIG. 19, one or more packaged chips 600, with the apparatus described above implemented on one chip or distributed over two or more of the chips, are manufactured by a semiconductor chip manufacturer. In some examples, the chip product 600 made by the semiconductor chip manufacturer may be provided as a semiconductor package which comprises a protective casing (e.g. made of metal, plastic, glass or ceramic) containing the semiconductor devices implementing the apparatus described above and connectors, such as lands, balls or pins, for connecting the semiconductor devices to an external environment. Where more than one chip 600 is provided, these could be provided as separate integrated circuits (provided as separate packages), or could be packaged by the semiconductor provider into a multi-chip semiconductor package (e.g. using an interposer, or by using three-dimensional integration to provide a multi-layer chip product comprising two or more vertically stacked integrated circuit layers).

In some examples, a collection of chiplets (i.e. modular chips combined to provide the functionality of a single chip) may itself be referred to as a chip. A chiplet may be packaged individually in a semiconductor package and/or together with other chiplets into a multi-chiplet semiconductor package (e.g. using an interposer, or by using three-dimensional integration to provide a multi-layer chiplet product comprising two or more vertically stacked integrated circuit layers).

The one or more packaged chips 600 are assembled on a board 602 together with at least one system component 604 to provide a system 606. For example, the board may comprise a printed circuit board. The board substrate may be made of any of a variety of materials, e.g. plastic, glass, ceramic, or a flexible substrate material such as paper, plastic or textile material. The at least one system component 604 comprise one or more external components which are not part of the one or more packaged chip(s) 600. For example, the at least one system component 604 could include, for example, any one or more of the following: another packaged chip (e.g. provided by a different manufacturer or produced on a different process node), an interface module, a resistor, a capacitor, an inductor, a transformer, a diode, a transistor and/or a sensor.

A chip-containing product 616 is manufactured comprising the system 606 (including the board 602, the one or more chips 600 and the at least one system component 604) and one or more product components 612. The product components 612 comprise one or more further components which are not part of the system 606. As a non-exhaustive list of examples, the one or more product components 612 could include a user input/output device such as a keypad, touch screen, microphone, loudspeaker, display screen, haptic device, etc. ; a wireless communication transmitter/receiver; a sensor; an actuator for actuating mechanical motion; a thermal control device; a further packaged chip; an interface module; a resistor; a capacitor; an inductor; a transformer; a diode; and/or a transistor. The system 606 and one or more product components 612 may be assembled on to a further board 614.

The board 602 or the further board 614 may be provided on or within a device housing or other structural support (e.g. a frame or blade) to provide a product which can be handled by a user and/or is intended for operational use by a person or company.

The system 606 or the chip-containing product 616 may be at least one of: an end-user product, a machine, a medical device, a computing or telecommunications infrastructure product, or an automation control system. For example, as a non-exhaustive list of examples, the chip-containing product could be any of the following: a telecommunications device, a mobile phone, a tablet, a laptop, a computer, a server (e.g. a rack server or blade server), an infrastructure device, networking equipment, a vehicle or other automotive product, industrial machinery, consumer device, smart card, credit card, smart glasses, avionics device, robotics device, camera, television, smart television, DVD players, set top box, wearable device, domestic appliance, smart meter, medical device, heating/lighting control device, sensor, and/or a control system for controlling public infrastructure equipment such as smart motorway or traffic lights.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, SystemVerilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioural representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

Some example configurations are set out in the following numbered clauses:
1. An apparatus comprising:
   transmission circuitry configured to transmit data over a communication path to a recipient device; and
   compression circuitry, responsive to a given data burst comprising a plurality N of data blocks associated with a sequence of addresses within a given address range, to determine, in dependence on compression criteria, whether to apply a compression scheme to the given data burst to cause one or more data blocks of the given data burst to be represented in a compressed form when transmitted over the communication path;
   wherein:
   the transmission circuitry is configured, absent the compression circuitry applying the compression scheme to the given data burst, to transmit the given data burst as a series of N beats over the communication path, where each beat is used to transmit a corresponding data block;
   the transmission circuitry is configured, when the compression circuitry applies the compression scheme to the given data burst, to transmit the given data burst by transmitting over the communication path, in a given beat, metadata that comprises at least compression indication data to identify each data block of the given data burst that is in the compressed form, and to transmit at least any uncompressed data blocks of the given data burst in one or more further beats; and
   the transmission circuitry is configured to notify the recipient device when the compression scheme has been applied to the given data burst.
2. An apparatus as in Clause 1, wherein the transmission circuitry is further configured, when the compression circuitry applies the compression scheme to the given data burst, to transmit over the communication path, in one or more additional beats, supplementary information sufficient to enable the recipient device to determine the data value of each data block that is in the compressed form.
3. An apparatus as in Clause 1 or Clause 2, wherein:
   the compression circuitry is arranged to select the compression scheme from amongst a plurality of compression schemes; and
   the transmission circuitry is arranged, when the compression circuitry applies the compression scheme to the given data burst, to signal to the recipient device which compression scheme amongst the plurality of compression schemes has been applied.
4. An apparatus as in any preceding clause, wherein the compression scheme applied by the compression circuitry to the given data burst is selected taking into account at least one of the following criteria:
   a type of data contained within the given data burst;
   a memory region associated with the given address range;
   compression schemes supported by the recipient device.
5. An apparatus as in any preceding clause, wherein in accordance with the compression scheme applied by the compression circuitry, at least one default value is defined and identified to the recipient device, and the compression circuitry is arranged to generate the compression indication data to identify, for each defined default value, each data block of the given data burst that has that default value.
6. An apparatus as in any preceding clause, further comprising:
   a data history buffer accessible to the compression circuitry, and used to store one or more data values output to the recipient device over the communication path;
   wherein:
   the recipient device is configured to reconstruct the data history buffer content using the data values received over the communication path; and
   in accordance with the compression scheme applied by the compression circuitry, the compression circuitry is arranged to generate the compression indication data to identify each data block of the given data burst that has a data value matching a stored data value in an entry of the data history buffer, and for each identified data block to generate an entry indicator to identify the entry of the data history buffer in which the data value for that identified data block is stored; and
   the transmission circuitry is further configured, when the compression circuitry applies the compression scheme to the given data burst, to transmit over the communication path, in one or more additional beats, each entry indicator generated by the compression circuitry.
7. An apparatus as in Clause 6, wherein:
   in accordance with the compression scheme applied by the compression circuitry, the compression circuitry is arranged to generate the compression indication data to additionally identify each data block of the given data burst that has a data value within a defined range of a stored data value in an entry of the data history buffer, and for each additionally identified data block to generate an entry indicator to identify the entry of the data history buffer, and an associated offset value to be applied to the data value stored in the identified entry in order to produce the data value for the additionally identified data block; and
   the transmission circuitry is further configured, when the compression circuitry applies the compression scheme to the given data burst, to transmit over the communication path, in the one or more additional beats, each entry indicator and the associated offset value generated by the compression circuitry.
8. An apparatus as in Clause 6 or Clause 7, wherein at least one entry in the data history buffer is used to store a chosen defined data value and is prevented from being overwritten.
9. An apparatus as in any preceding clause, further comprising:
   a transmission buffer to store a plurality of data bursts awaiting transmission over the communication path;
   wherein the compression circuitry is arranged to reorder data bursts stored within the transmission buffer when such a reordering would enable an improvement in compression efficiency when applying a selected compression scheme to one or more data bursts in the plurality of data bursts.
10. An apparatus as in any preceding clause, wherein, in the presence of a defined condition, the compression circuitry is arranged, for each data block, to apply the compression scheme independently to the data bits in different subsets of the data block.
11. An apparatus as in any preceding clause, wherein:
   the transmission circuitry is arranged to issue a command to the recipient device in association with each data burst sent over the communication path, to identify to the recipient device how the associated data burst should be handled by the recipient device; and
   the transmission circuitry is arranged, following transmission of a given command in association with the given data burst, to control timing of issuance of a next command for a next data burst to be transmitted after the given data burst, to take into account a number of beats required to transmit the given data burst, where the number of beats is dependent on a degree of compression achieved by the compression circuitry for the given data burst.
12. An apparatus as in any preceding clause, wherein the apparatus is a memory controller, and the recipient device is a memory device.
13. An apparatus as in Clause 12, wherein:
   the apparatus is configured to use the communication path for both write data to be written to the memory device, and to receive read data read from the memory device;
   the transmission circuitry is arranged to issue a write command to the memory device in association with a data burst sent over the communication path comprising data to be written to the memory device, and is configured to issue a read command to the memory device when requesting a data burst containing read data to be returned over the communication path from the memory device to the memory controller;
   the given data burst contains write data to be written to the memory device, and a next data burst to be sent over the communication path following the given data burst is a read data burst to provide read data read from the memory device; and
   the transmission circuitry is arranged, following transmission of a given write command in association with the given data burst, to control timing of issuance of a read command used to identify the next data burst to take into account a number of beats required to transmit the given data burst, where the number of beats is dependent on a degree of compression achieved by the compression circuitry for the given data burst.
14. An apparatus as in any of clauses 1 to 10, wherein:
   the apparatus is a memory device and the recipient device is a memory controller;
   the memory device is arranged to generate a read data burst containing read data read from the memory device in response to a read command received from the memory controller; and
   the memory device is configured to transmit a sideband signal in association with the read data burst sent over the communication path, to indicate to the memory controller whether the compression scheme has been applied to the read data burst.
15. An apparatus as in Clause 14, wherein:
   the memory device is configured, when receiving a write data burst from the memory controller in a compressed format as a result of the write data burst having had a compression scheme applied thereto by the memory controller, to store the write data burst in the memory device in the compressed format, and to set an associated state flag in the memory device to identify that the write data burst has been stored in the compressed format; and
   the memory device is arranged, when reading data from the memory device to generate the read data burst, to determine whether the associated state flag is set, and when the associated state flag is set, to output the read data burst in the compressed format along with the associated sideband signal to indicate to the memory controller that the compression scheme has been applied.
16. An apparatus as in Clause 14 or Clause 15, further comprising:
   a read queue into which to receive a plurality of read commands from the memory controller;
   wherein when a read data burst is issued in response to a given read command, the given read command is removed from the read queue, and the memory device is configured to begin processing a next read command in the read queue.
17. A method of transmitting data bursts over a communication path to a recipient device, comprising:
   employing compression circuitry to determine, for a given data burst comprising a plurality N of data blocks associated with a sequence of addresses within a given address range, in dependence on compression criteria, whether to apply a compression scheme to the given data burst to cause one or more data blocks of the given data burst to be represented in a compressed form when transmitted over the communication path;
   absent the compression circuitry applying the compression scheme to the given data burst, transmitting the given data burst as a series of N beats over the communication path, where each beat is used to transmit a corresponding data block;
   when the compression circuitry applies the compression scheme to the given data burst, transmitting the given data burst by transmitting over the communication path, in a given beat, metadata that comprises at least compression indication data to identify each data block of the given data burst that is in the compressed form, and transmitting at least any uncompressed data blocks of the given data burst in one or more further beats; and
   notifying the recipient device when the compression scheme has been applied to the given data burst.
18. A system comprising:
   the apparatus of any of clauses 1 to 16, implemented in at least one packaged chip;
   at least one system component; and
   a board,
   wherein the at least one packaged chip and the at least one system component are assembled on the board.
19. A chip-containing product comprising the system of clause 18, wherein the system is assembled on a further board with at least one other product component.
20. A computer-readable medium storing computer-readable code for fabrication of the apparatus of any of clauses 1 to 16.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

In the present application, lists of features preceded with the phrase “at least one of” mean that any one or more of those features can be provided either individually or in combination. For example, “at least one of: [A], [B] and [C]” encompasses any of the following options: A alone (without B or C), B alone (without A or C), C alone (without A or B), A and B in combination (without C), A and C in combination (without B), B and C in combination (without A), or A, B and C in combination.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope of the invention as defined by the appended claims.

1. An apparatus comprising:
transmission circuitry configured to transmit data over a communication path to a recipient device; and
compression circuitry, responsive to a given data burst comprising a plurality N of data blocks associated with a sequence of addresses within a given address range, to determine, in dependence on compression criteria, whether to apply a compression scheme to the given data burst to cause one or more data blocks of the given data burst to be represented in a compressed form when transmitted over the communication path;
wherein:
the transmission circuitry is configured, absent the compression circuitry applying the compression scheme to the given data burst, to transmit the given data burst as a series of N beats over the communication path, where each beat is used to transmit a corresponding data block;
the transmission circuitry is configured, when the compression circuitry applies the compression scheme to the given data burst, to transmit the given data burst by transmitting over the communication path, in a given beat, metadata that comprises at least compression indication data to identify each data block of the given data burst that is in the compressed form, and to transmit at least any uncompressed data blocks of the given data burst in one or more further beats; and
the transmission circuitry is configured to notify the recipient device when the compression scheme has been applied to the given data burst.

2. An apparatus as claimed in claim 1, wherein the transmission circuitry is further configured, when the compression circuitry applies the compression scheme to the given data burst, to transmit over the communication path, in one or more additional beats, supplementary information sufficient to enable the recipient device to determine the data value of each data block that is in the compressed form.

3. An apparatus as claimed in claim 1, wherein:
the compression circuitry is arranged to select the compression scheme from amongst a plurality of compression schemes; and
the transmission circuitry is arranged, when the compression circuitry applies the compression scheme to the given data burst, to signal to the recipient device which compression scheme amongst the plurality of compression schemes has been applied.

4. An apparatus as claimed in claim 1, wherein the compression scheme applied by the compression circuitry to the given data burst is selected taking into account at least one of the following criteria:
a type of data contained within the given data burst;
a memory region associated with the given address range;
compression schemes supported by the recipient device.

5. An apparatus as claimed in claim 1, wherein in accordance with the compression scheme applied by the compression circuitry, at least one default value is defined and identified to the recipient device, and the compression circuitry is arranged to generate the compression indication data to identify, for each defined default value, each data block of the given data burst that has that default value.

6. An apparatus as claimed in claim 1, further comprising:
a data history buffer accessible to the compression circuitry, and used to store one or more data values output to the recipient device over the communication path;
wherein:
the recipient device is configured to reconstruct the data history buffer content using the data values received over the communication path; and
in accordance with the compression scheme applied by the compression circuitry, the compression circuitry is arranged to generate the compression indication data to identify each data block of the given data burst that has a data value matching a stored data value in an entry of the data history buffer, and for each identified data block to generate an entry indicator to identify the entry of the data history buffer in which the data value for that identified data block is stored; and
the transmission circuitry is further configured, when the compression circuitry applies the compression scheme to the given data burst, to transmit over the communication path, in one or more additional beats, each entry indicator generated by the compression circuitry.

7. An apparatus as claimed in claim 6, wherein:
in accordance with the compression scheme applied by the compression circuitry, the compression circuitry is arranged to generate the compression indication data to additionally identify each data block of the given data burst that has a data value within a defined range of a stored data value in an entry of the data history buffer, and for each additionally identified data block to generate an entry indicator to identify the entry of the data history buffer, and an associated offset value to be applied to the data value stored in the identified entry in order to produce the data value for the additionally identified data block; and
the transmission circuitry is further configured, when the compression circuitry applies the compression scheme to the given data burst, to transmit over the communication path, in the one or more additional beats, each entry indicator and the associated offset value generated by the compression circuitry.

8. An apparatus as claimed in claim 6, wherein at least one entry in the data history buffer is used to store a chosen defined data value and is prevented from being overwritten.

9. An apparatus as claimed in claim 1, further comprising:
a transmission buffer to store a plurality of data bursts awaiting transmission over the communication path;
wherein the compression circuitry is arranged to reorder data bursts stored within the transmission buffer when such a reordering would enable an improvement in compression efficiency when applying a selected compression scheme to one or more data bursts in the plurality of data bursts.

10. An apparatus as claimed in claim 1, wherein, in the presence of a defined condition, the compression circuitry is arranged, for each data block, to apply the compression scheme independently to the data bits in different subsets of the data block.

11. An apparatus as claimed in claim 1, wherein:
the transmission circuitry is arranged to issue a command to the recipient device in association with each data burst sent over the communication path, to identify to the recipient device how the associated data burst should be handled by the recipient device; and
the transmission circuitry is arranged, following transmission of a given command in association with the given data burst, to control timing of issuance of a next command for a next data burst to be transmitted after the given data burst, to take into account a number of beats required to transmit the given data burst, where the number of beats is dependent on a degree of compression achieved by the compression circuitry for the given data burst.

12. An apparatus as claimed in claim 1, wherein the apparatus is a memory controller, and the recipient device is a memory device.

13. An apparatus as claimed in claim 12, wherein:
the apparatus is configured to use the communication path for both write data to be written to the memory device, and to receive read data read from the memory device;
the transmission circuitry is arranged to issue a write command to the memory device in association with a data burst sent over the communication path comprising data to be written to the memory device, and is configured to issue a read command to the memory device when requesting a data burst containing read data to be returned over the communication path from the memory device to the memory controller;
the given data burst contains write data to be written to the memory device, and a next data burst to be sent over the communication path following the given data burst is a read data burst to provide read data read from the memory device; and
the transmission circuitry is arranged, following transmission of a given write command in association with the given data burst, to control timing of issuance of a read command used to identify the next data burst to take into account a number of beats required to transmit the given data burst, where the number of beats is dependent on a degree of compression achieved by the compression circuitry for the given data burst.

14. An apparatus as claimed in claim 1, wherein:
the apparatus is a memory device and the recipient device is a memory controller;
the memory device is arranged to generate a read data burst containing read data read from the memory device in response to a read command received from the memory controller; and
the memory device is configured to transmit a sideband signal in association with the read data burst sent over the communication path, to indicate to the memory controller whether the compression scheme has been applied to the read data burst.

15. An apparatus as claimed in claim 14, wherein:
the memory device is configured, when receiving a write data burst from the memory controller in a compressed format as a result of the write data burst having had a compression scheme applied thereto by the memory controller, to store the write data burst in the memory device in the compressed format, and to set an associated state flag in the memory device to identify that the write data burst has been stored in the compressed format; and
the memory device is arranged, when reading data from the memory device to generate the read data burst, to determine whether the associated state flag is set, and when the associated state flag is set, to output the read data burst in the compressed format along with the associated sideband signal to indicate to the memory controller that the compression scheme has been applied.

16. An apparatus as claimed in claim 14, further comprising:
a read queue into which to receive a plurality of read commands from the memory controller;
wherein when a read data burst is issued in response to a given read command, the given read command is removed from the read queue, and the memory device is configured to begin processing a next read command in the read queue.

17. A method of transmitting data bursts over a communication path to a recipient device, comprising:
employing compression circuitry to determine, for a given data burst comprising a plurality N of data blocks associated with a sequence of addresses within a given address range, in dependence on compression criteria, whether to apply a compression scheme to the given data burst to cause one or more data blocks of the given data burst to be represented in a compressed form when transmitted over the communication path;
absent the compression circuitry applying the compression scheme to the given data burst, transmitting the given data burst as a series of N beats over the communication path, where each beat is used to transmit a corresponding data block;
when the compression circuitry applies the compression scheme to the given data burst, transmitting the given data burst by transmitting over the communication path, in a given beat, metadata that comprises at least compression indication data to identify each data block of the given data burst that is in the compressed form, and transmitting at least any uncompressed data blocks of the given data burst in one or more further beats; and
notifying the recipient device when the compression scheme has been applied to the given data burst.

18. A system comprising:
the apparatus of claim 1, implemented in at least one packaged chip;
at least one system component; and
a board,
wherein the at least one packaged chip and the at least one system component are assembled on the board.

19. A chip-containing product comprising the system of claim 18, wherein the system is assembled on a further board with at least one other product component.

20. A computer-readable medium storing computer-readable code for fabrication of the apparatus of claim 1.
